(19) United States
(12) Patent Application Publication
(10) Pub. No.: US 2026/0278709 A1
(43) Pub. Date: Sep. 17, 2026

(54) Computer-implemented and interactive real estate contract generation and editing process

(71) Applicant: Anthony Makins, Coconut Creek, FL (US)

(72) Inventor: Anthony Makins, Coconut Creek, FL (US)

(21) Appl. No.: 19/678,098

(22) Filed: May 14, 2026

Related U.S. Application Data
(63) Continuation-in-part of application No. 18/372,494, filed on Sep. 25, 2023, now abandoned.
Application No. 18/372,494 is a continuation-in-part of application No. 17/526,150, filed on Nov. 15, 2021, now Pat. No. 11,769,219.

(51) Int. Cl. G06Q 50/16; G06F 3/04817; G06Q 50/18

(52) U.S. Cl. CPC G06Q 50/16; G06F 3/04817; G06Q 50/188

(57) ABSTRACT

A computer-implemented and interactive real estate contract generation and editing process that allows a user to couple with a remote serve and initiate a network-based remote easy contract formation session that displays a plurality of independent and sequentially viewable windows on the GUI of a user's device and that includes contract formation text for a user to insert contract formation data therein and with the assist of an AI module. Beneficially, the process includes associating the contract formation data using with preformed paragraphs in a digital contractual document using an array structure and/or using AI to read and review the contract formation data before inserting into the digital document, thereby ensure the contract is formed accurately and efficiently.

### FIELD OF THE INVENTION

The present invention relates generally to real estate contracts, and, more particularly, relates to a computer-implemented and interactive real estate contract generation and editing process.

### BACKGROUND OF THE INVENTION

Real estate purchase agreements are generally drafted by a few select categories of qualified individuals, namely, real estate agents or attorneys. As a result, parties looking to buy and/or sell real estate are typically forced to solicit the assistance of these qualified individuals and wait for said individuals to draft, edit, revise, and finalize the subject purchase agreement before being able to proceed with the additional steps involved in a purchase and sale transaction, e.g., appraisal, financing, closing, etc. In many cases, this dependence on such a select group of individuals results in the loss of valuable time that may jeopardize the success of purchase and sale transactions, particularly where such transactions are time-sensitive, subject to conditions, or occurring in a market with more demand than supply.

There are some known computer-implemented methods and systems for generating contracts. These known methods and systems fail to provide adequate information and direction to putative buyers and/or seller. Additionally, these known methods and systems are also typically confusing to navigate through.

Therefore, a need exists to overcome the problems with the prior art as discussed above.

### SUMMARY OF THE INVENTION

The invention provides a computer-implemented and interactive real estate contract generation and editing process that overcomes the hereinafore-mentioned disadvantages of the heretofore-known devices and methods of this general type and that beneficially allows any user to easily, quickly, and conveniently draft purchase and sale transactions from the comfort of an electronic device owned or utilized by the user.

With the foregoing and other objects in view, there is provided, in accordance with the invention, a computer-implemented and interactive real estate contract generation and editing process comprising the steps of providing a first electronic computing device of a first user and a computer server; communicatively coupling the first electronic computing device of the first user to the computer server over a wireless communication network and generating a digital graphical user interface (GUI) on an electronic display of the first computing device with a plurality of digital data input fields operably configured to receive alpha-numeric text; initiating a network-based remote easy contract formation session that includes selecting a plurality of GUI icons on the electronic display of the first computing device and inputting contract formation data into each of the plurality of digital data input fields; and generating a digital document in the network-based remote easy contract formation session with a plurality of independent preformed paragraphs each having at least one fillable contract data field disposed therein and assigned and filled in with, using an array data structure, to one of the plurality of digital data input fields to create a finalized digital document without any fillable contract data field therein and that is downloadable to the electronic display of the first computing device.

In accordance with another feature, the first electronic computing device of the first user is geographically located at a different physical building location than the computer server.

In accordance with another feature, an embodiment of the present invention includes the step of communicatively coupling the first electronic computing device of the first user to the computer server over the wireless communication network and registering into a user account resident on the computer server before generating the digital GUI on the electronic display of the first computing device.

In accordance with a further feature of the present invention, the computer-implemented and interactive real estate contract generation and editing process further comprises the step of generating the finalized digital document without fillable contract data field therein and that is transferrable from the electronic display of the first computing device to a second computing device of a second user over the wireless communication network.

In accordance with a further feature of the present invention, the computer-implemented and interactive real estate contract generation and editing process also includes a digital informational icon disposed proximal to each of the plurality of digital data input fields and having informational text included therein; and displaying the informational text on the electronic display of the first computing device upon selectively modulating the digital informational icon.

In accordance with the present invention, an embodiment of the present invention includes a plurality of independent and sequentially viewable windows within the network-based remote easy contract formation session that collectively form part of selecting the plurality of GUI icons on the electronic display of the first computing device and the inputting contract formation data into each of the plurality of digital data input fields, the plurality of independent and sequentially viewable windows generating before generation of the digital document in the network-based remote easy contract formation session with the plurality of independent preformed paragraphs.

In accordance with another feature, an embodiment of the present invention also includes the step of initiating, in lieu of the network-based remote easy contract formation session, a network-based remote do-it-yourself contract formation session that includes generating a digital document with a plurality of GUI icons on the electronic display of the first computing device, with a plurality of independent preformed paragraphs each having at least one digital data input field therein, and filling in the at least one digital data input field to create a finalized digital document without any fillable contract data field therein and that is downloadable to the electronic display of the first computing device.

In accordance with yet another feature, an embodiment of the present invention includes a plurality of independent and sequentially viewable windows within the network-based remote do-it-yourself contract formation session that collectively form part of the digital document with the plurality of GUI icons on the electronic display of the first computing device.

In accordance with a further feature of the present invention, the computer-implemented and interactive real estate contract generation and editing process also includes selectively choosing on the first electronic computing device of a first user one of either the easy contract formation session or the do-it-yourself contract formation session.

The present invention also provides a computer-implemented and interactive real estate contract generation and editing process comprising the steps of providing a first electronic computing device of a first user and a computer server; communicatively coupling the first electronic computing device of the first user to the computer server over a wireless communication network and generating a digital graphical user interface (GUI) on an electronic display of the first computing device with a plurality of digital data input fields operably configured to receive alpha-numeric text; initiating a network-based remote easy contract formation session that includes inputting contract formation data into each of the plurality of digital data input fields in a plurality of independent and sequentially viewable windows that collectively form part of selecting the plurality of GUI icons on the electronic display of the first computing device and the inputting contract formation data into each of the plurality of digital data input fields, the plurality of independent and sequentially viewable windows generating before generation of the digital document in the network-based remote easy contract formation session with the plurality of independent preformed paragraphs; and generating a digital document in the network-based remote easy contract formation session with a plurality of independent preformed paragraphs each having at least one fillable contract data input field disposed therein and assigned and filled in with one of the plurality of contract formation data to create a finalized digital document.

In accordance with the present invention, a computer-implemented and interactive real estate contract generation and editing process comprising the steps of providing a first electronic computing device of a first user and a computer server; communicatively coupling the first electronic computing device of the first user to the computer server over a wireless communication network and generating a digital graphical user interface (GUI) on an electronic display of the first computing device with a plurality of digital data input fields operably configured to receive alpha-numeric text; and initiating a network-based remote do-it-yourself contract formation session that includes generating a digital document on the electronic display of the first computing device, with a plurality of independent preformed paragraphs each having at least one digital data input field therein, and filling in the at least one digital data input field with contract formation data to create a finalized digital document.

Additional embodiments of the computer-implemented and interactive real estate contract generation and editing process include providing a first electronic computing device of a first user and having an electronic display configured to display a digital graphical user interface (GUI) and a computer server, communicatively coupling the first electronic computing device of the first user to the computer server over a wireless communication network, and initiating a network-based remote easy contract formation session. The network-based remote easy contract formation session may beneficially include generating a plurality of independent and sequentially viewable windows on the GUI of the electronic display of the first electronic computing device, wherein each of the independent and sequentially viewable windows displaying at least one contract formation text therein and at least one digital data input field, receiving alpha-numeric text corresponding to contract formation data within each of the plurality of digital data input fields from the first user, executing a software-based learning tool ascertaining the contract formation data and comparing it to a learning data structure to ascertain a match corresponding to a user understanding of the at least one contract formation text associated with each of the independent and sequentially viewable windows, and generating, after completion of the plurality of independent and sequentially viewable windows and at a conclusion of the network-based remote easy contract formation session, a digital document with a plurality of independent paragraphs each having at least one fillable contract data field disposed therein and assigned to and filled in with at a portion of software-defined and software-selected contract formation data using the software-based learning tool to create a finalized digital document without any fillable contract data field therein.

Additional embodiments of the invention include plurality of digital data input fields each being identified by an assigned array index on an array data structure.

Further embodiments of the invention may include the plurality of digital data input fields each having a GUI informational icon disposed proximal to each of the plurality of digital data input fields, the GUI informational icon having informational text included therein and displaying the informational text on the electronic display of the first computing device upon selectively modulating the GUI informational icon.

A computer-implemented and interactive real estate contract generation and editing process is also disclosed that includes providing a first electronic computing device of a first user and having an electronic display configured to display a digital graphical user interface (GUI) and a computer server, communicatively coupling the first electronic computing device of the first user to the computer server over a wireless communication network, and initiating a network-based remote easy contract formation session. The network-based remote easy contract formation session may also include generating a plurality of independent and sequentially viewable windows on the GUI of the electronic display of the first electronic computing device, wherein each of the independent and sequentially viewable windows displaying at least one contract formation text therein and at least one digital data input field identified by an assigned array index on an array data structure, receiving alpha-numeric text corresponding to contract formation data within each of the plurality of digital data input fields from the first user, and generating, after completion of the plurality of independent and sequentially viewable windows and at a conclusion of the network-based remote easy contract formation session, a digital document with a plurality of independent preformed paragraphs each having at least one fillable contract data field disposed therein and assigned to, using the array data structure with the assigned array index, and filled in with contract formation data received within each of the plurality of digital data input fields from the first user to create a finalized digital document without any fillable contract data field therein.

Although the invention is illustrated and described herein as embodied in a computer-implemented and interactive real estate contract generation and editing process, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a block diagram of a computer-implemented and interactive real estate contract generation and editing process, in accordance with one exemplary embodiment of the present invention;

FIG. 2 is a block diagram of the exemplary computing device utilized in the computer-implemented and interactive real estate contract generation and editing process of FIG. 1, in accordance with the present invention;

FIG. 3 is a process flow diagram depicting the steps associated with the computer-implemented and interactive real estate contract generation and editing process of FIG. 1, in accordance with one exemplary embodiment of the present invention;

FIG. 4 is a screen shot view of a sign-up page for users, in accordance with an exemplary embodiment of the present invention;

FIG. 5 is a screen shot view of a verification by email page for users, in accordance with the present invention;

FIGS. 6-7 are screen shot views of a verification by phone page for users, in accordance with the present invention;

FIG. 8 is a screen shot view of a sign-in page for users, in accordance with the present invention;

FIG. 9 is a screen shot view of a forgot-your-password page for users, in accordance with the present invention;

FIG. 10 is a screen shot view depicting the plurality of digital graphical user interface (GUI) icons of the computer-implemented and interactive real estate contract generation and editing process of FIG. 1, in accordance with the present invention;

FIG. 11 is a screen shot view depicting the plurality of digital data input fields, in accordance with the present invention;

FIGS. 12-41 are screen shot views depicting the plurality of digital data input fields of the network-based remote easy contract formation session, in accordance with an exemplary embodiment of the present invention;

FIG. 42 is a screen shot view of a summary page of the network-based remote easy contract formation session, in accordance with the present invention;

FIGS. 43A-B, 44A-B, 45A-B, 46A-B are screen shot views of the finalized digital document without any fillable contract data field therein of the network-based remote easy contract formation session, in accordance with the present invention;

FIGS. 47A-C and FIG. 48 are screen shot views of the plurality of digital data input fields for selling a home, in accordance with the present invention;

FIGS. 49-50 are screen shot views of the plurality of digital data input fields for requesting a professional list of properties available for purchase that fit the user's inputted criteria, in accordance with the present invention;

FIG. 51 is a screen shot view of a confirmation page for requesting a professional list of properties available for purchase that fit the user's inputted criteria, in accordance with the present invention;

FIG. 52 is a screen shot view of a consultation request page, in accordance with the present invention;

FIGS. 53A-B are screen shots of a direct message chat between a user and a real estate professional, in accordance with the present invention;

FIGS. 54A-C are screen shots of a property listing page, in accordance with the present invention;

FIGS. 55A-B, 56A-B, 57A-B, 58A-B, 59A-B, 60A-B, 61A-B, 62A-B are screen shot views depicting the plurality of digital data input fields in the network-based remote do-it-yourself contract formation session, in accordance with an exemplary embodiment of the present invention;

FIG. 63 is a screen shot view of a summary page of the network-based remote do-it-yourself contract formation session, in accordance with the present invention; and

FIGS. 64A-B, 65A-B, 66A-B, 67A-B are screen shots of the finalized digital document without any fillable contract data field therein of the network-based remote do-it-yourself contract formation session, in accordance with the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient computer-implemented and interactive real estate contract generation and editing process that enables users, namely, real estate sellers and purchasers, to draft, edit, and finalize real estate purchase and sale agreements themselves rather than having to be dependent or reliant on a third party to do so, e.g., on a real estate agent or attorney. Embodiments of the invention provide a process that may be performed remotely over a wireless communication network and from any geographic location for greater convenience. In addition, embodiments of the invention provide a contract generation and editing process that is simple and easy to perform such that it may be performed by professionals as well as users who are inexperienced in the real estate industry without sacrificing the substantive integrity of the contract. The present invention also beneficially enables a user to selectively toggle or switch between an “easy” mode and a “do-it-yourself” mode, wherein the “easy” mode poses specific, directed questions to the user, the responses to which are then inserted into the digital real estate contract to form the finalized digital document, whereas the “do-it-yourself” mode grants the user the ability to fill in digital data input fields directly onto the digital document itself until a finalized digital document is achieved. As used herein, the term “easy” is solely used for naming purposes and should not be construed otherwise or interpreted in any other matter.

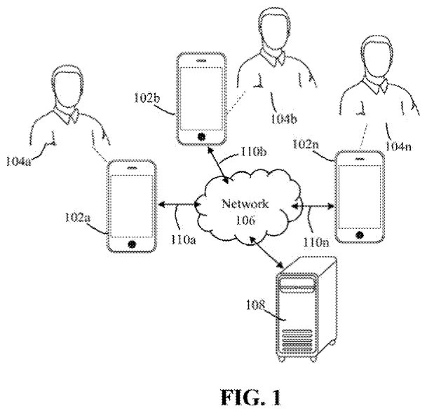

Referring now to FIG. 1, one embodiment of the present invention is shown in a block diagram view. FIG. 1 shows several advantageous features of the present invention, but, as will be described below, the invention can be provided in several shapes, sizes, combinations of features and components, and varying numbers and functions of the components. The first example of a computer-implemented and interactive real estate contract generation and editing process (referred to herein as the “process 300” for brevity), as shown in FIGS. 1-3, includes a first Step 302 of the process 300 which comprises providing a first electronic computing device 102a of a first user 104a, the electronic computing device 102a having an electronic display 210, a memory 206, a user input interface 202, and a network interface 204. In preferred embodiments, the first electronic computing device 102a may consist of a cell phone, smart phone, laptop, tablet, desktop computer, or other comparable electronic computing or processing device 208. The memory 206 is non-transitory wherein “non-transitory” is defined as a resident memory. The electronic computing devices 102a-n which may be a cellphone or tablet, for example, are operable to execute programming instructions embodied in the process 300 that can be received from a computer server 108 via a wide area network (WAN) 106. Said differently, the electronic computing devices 102a-n are operable to execute the programming instructions received from the computer server 108 over the WAN 106. In other embodiments, the process 300 is embodied in a web-based software application, a desktop software application, or a mobile device software app. In one embodiment, the WAN is the Internet. The Internet represents a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, the network 106 also may be implemented as a number of different types of networks, such as for example, an Intranet, a local area network (LAN), or a cellular network. FIG. 1 is intended as an example, and not as an architectural limitation for the present invention. As shown in FIG. 1, the network 106 includes connections 110a-n, which are the medium used to provide communication links between various devices and computers connected together within the network 106. The connections 110a-n may be wired or wireless connections, but said connections are preferably wireless. A few exemplary wired connections are cable, phone line, and fiber optic. Exemplary wireless connections include radio frequency (RF) and infrared radiation (IR) transmission. Many other wired and wireless connections are known in the art and can be used with the present invention.

The network interface 204 may include one or more network interface cards (NIC) or a network controller. In some embodiments, the network interface 204 may include a personal area network (PAN) interface. The PAN interface may provide the capability for the user's computing devices to network using a short-range communication protocol, for example, a Bluetooth communication protocol. The PAN interface may permit one personal computing device to connect wirelessly to another personal computing device via a peer-to-peer connection. The network interface 204 may also include a local area network (LAN) interface. The LAN interface may be, for example, an interface to a wireless LAN, such as a Wi-Fi network. The range of the LAN interface may generally exceed the range available via the PAN interface. Typically, a connection between two electronic devices via the LAN interface may involve communication through a network router or other intermediary device. Additionally, the network interface 204 may include the capability to connect to a wide area network (WAN) via a WAN interface. The WAN interface may permit a connection to, for example, a cellular mobile communications network. The WAN interface may include communications circuitry, such as an antenna coupled to a radio circuit having a transceiver for transmitting and receiving radio signals via the antenna. The radio circuit may be configured to operate in a mobile communications network, including but not limited to global systems for mobile communications (GSM), code division multiple access (CDMA), wideband CDMA (WCDMA), and the like.

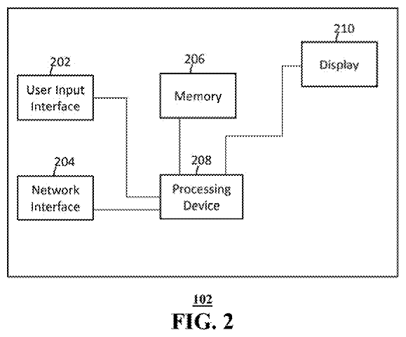

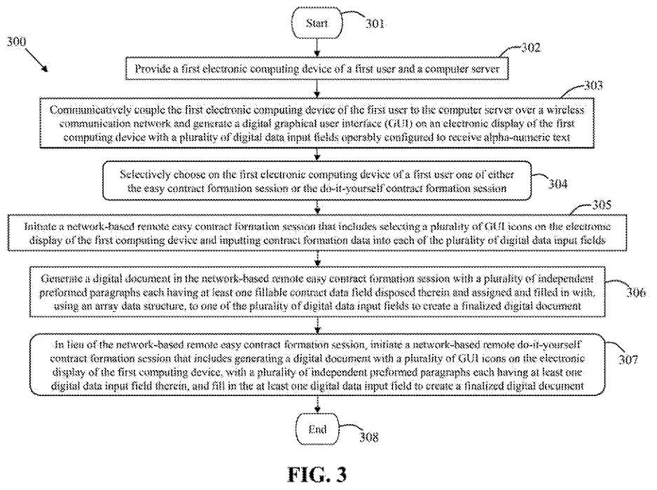

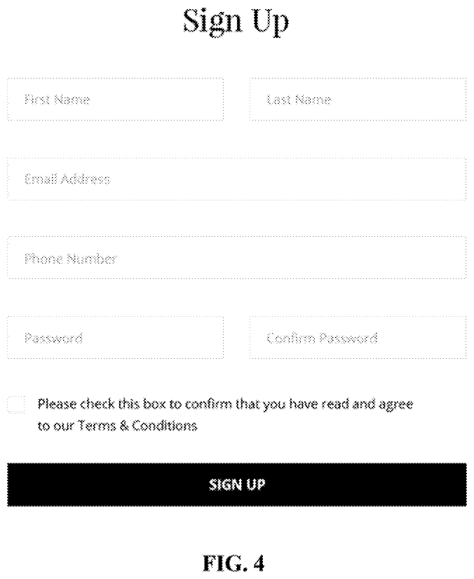

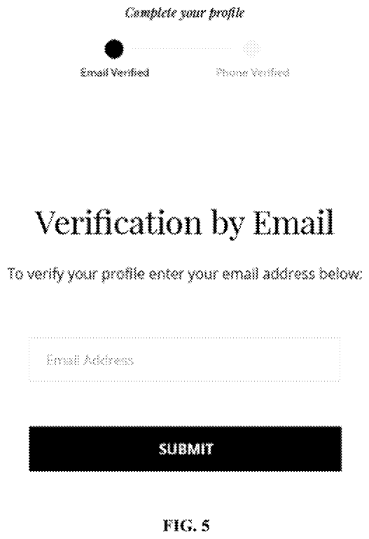

FIG. 3 will be described in conjunction with the process flow chart of FIGS. 1-2. Although FIG. 3 shows a specific order of executing the process 300 steps, the order of executing the steps may be changed relative to the order shown in certain embodiments. Also, two or more blocks shown in succession may be executed concurrently or with partial concurrence in some embodiments. Certain steps may also be omitted in FIG. 3 for the sake of brevity. In some embodiments, some or all of the process steps included in FIG. 3 can be combined into a single process.

A second Step 303 entails communicatively coupling the first electronic computing device 102a of the first user 104a to the computer server 108 over a wireless communication network 106 and generating a digital graphical user interface (GUI) 202 on an electronic display 210 of the first computing device 102a with a plurality of digital data input fields 1100a-n, wherein “n” refers to any number greater than one, operably configured to receive alpha-numeric text. In preferred embodiments, the process 300 is ran over a wireless communication network 106 though, as explained above, in alternate embodiments the process 300 may be run, for example, over wired networks. The plurality of digital data input fields 1100a-n may vary in form and substance. Specifically, the plurality of digital data input fields 1100a-n may be in the form of fill-in-the-blank input fields (as shown by 1100b), drop-down input fields (as shown by 1100n), pre-determined response input fields (as shown by 1100a), or a combination of the foregoing. For this reason, the term “alpha-numeric text” is defined as numerals, letters, punctuation, special characters, etc. whether pre-determined or inputted by the user. The specific substance of the plurality of digital data input fields 1100a-n may likewise vary in various embodiments but preferably relates to the contents of the real estate contract, e.g., identity of buyer(s), identity of seller(s), purchase price, method of payment (e.g., cash, loan, or other), length of offer, loan financing information, down payment information, title agent/company information, personal property, etc., wherein the foregoing subsets of information would be included only if and when applicable to the particular transaction at issue.

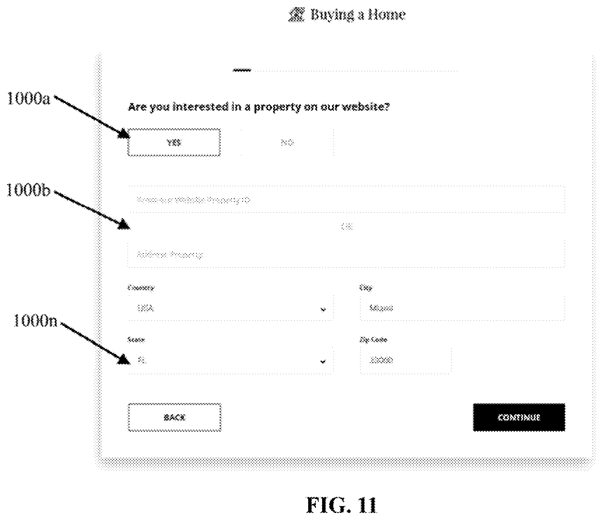

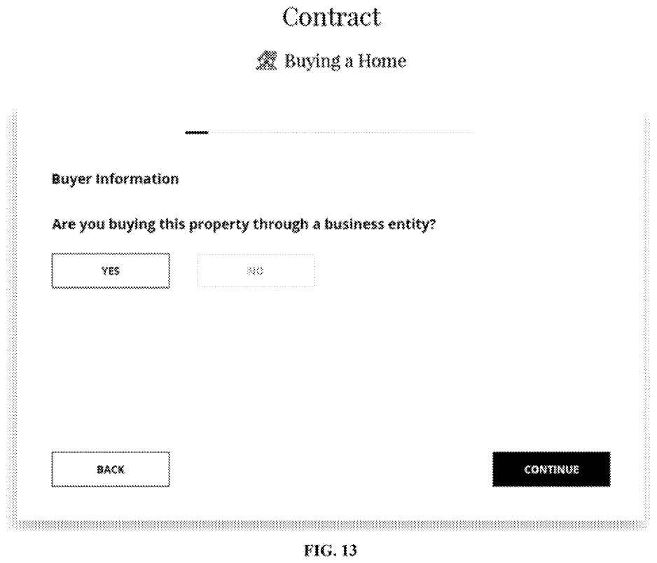

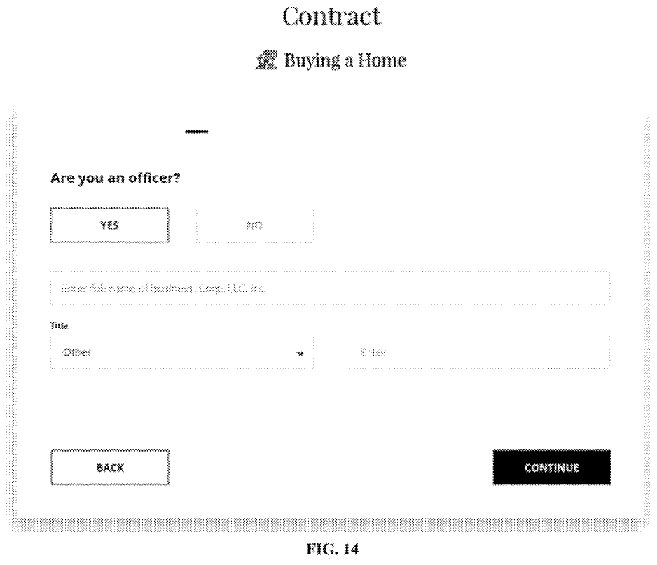

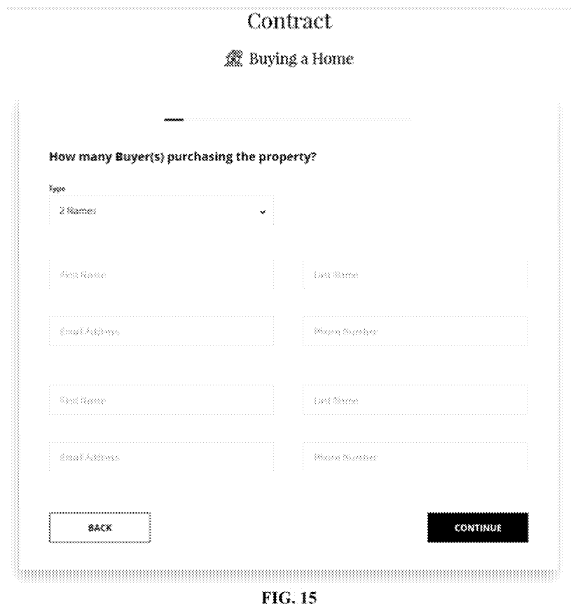

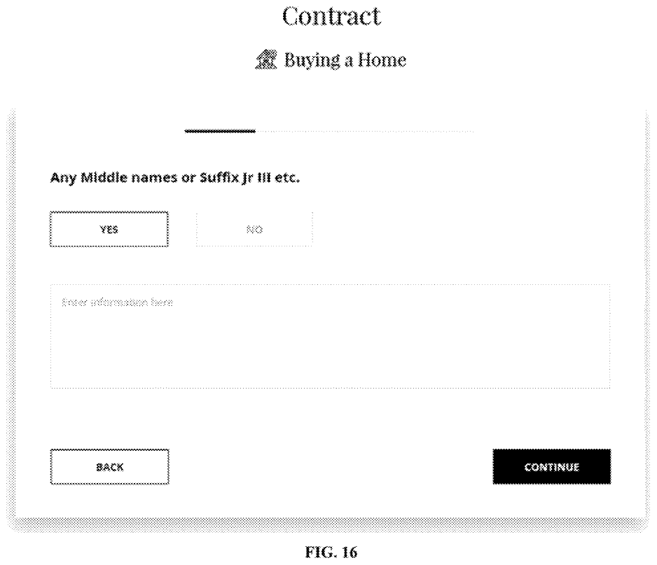

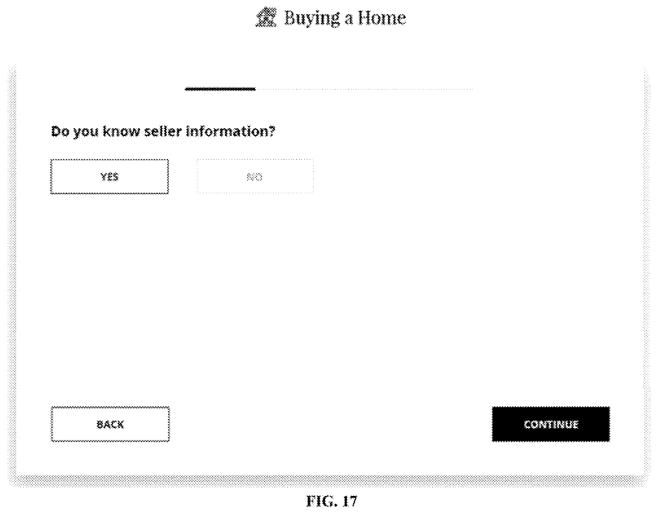

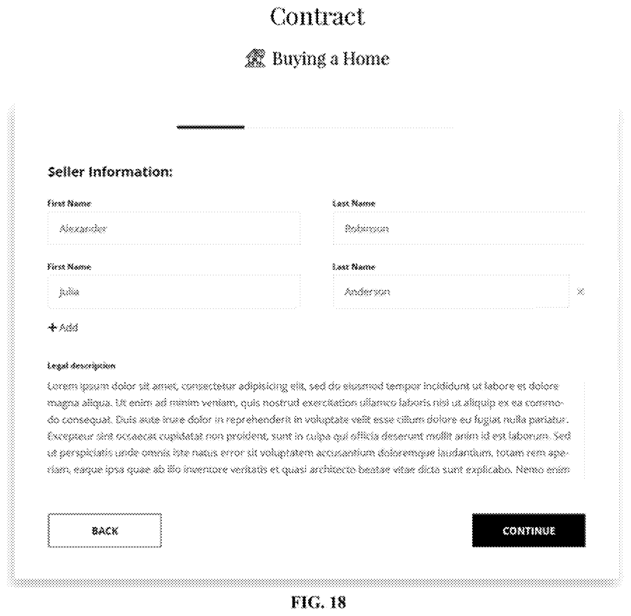

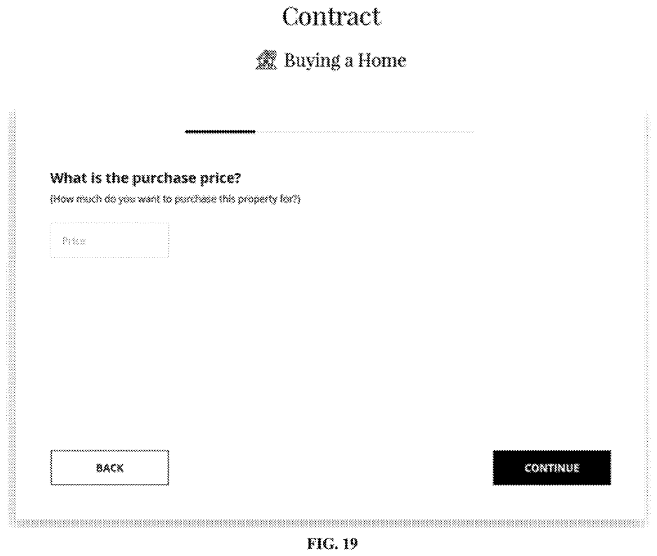

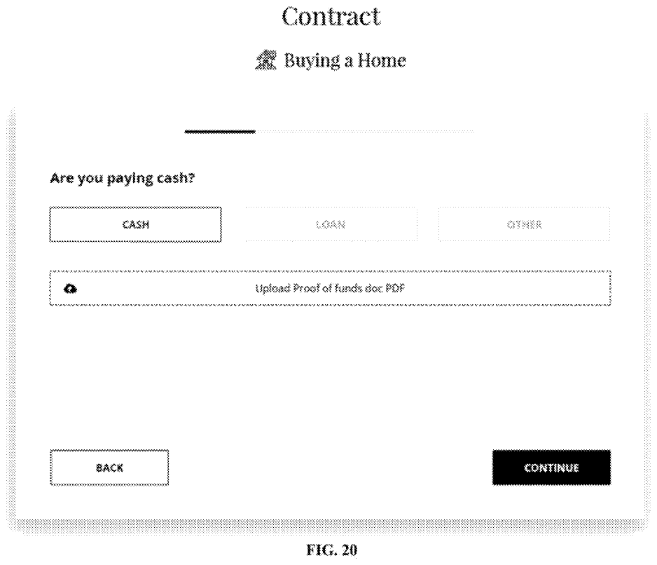

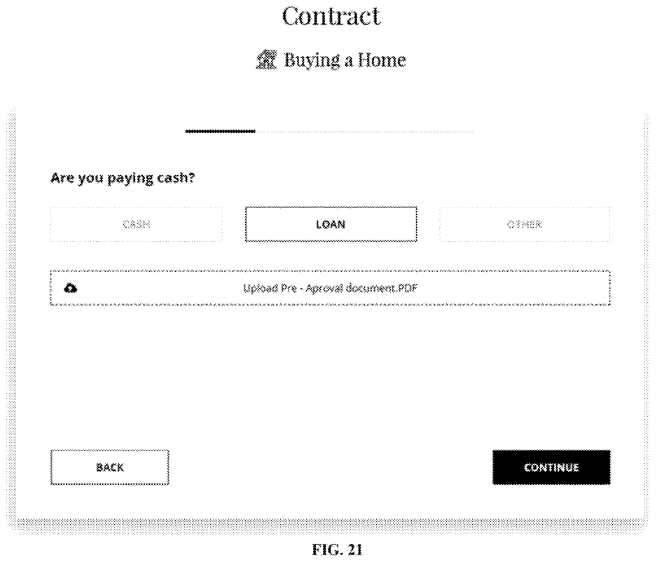

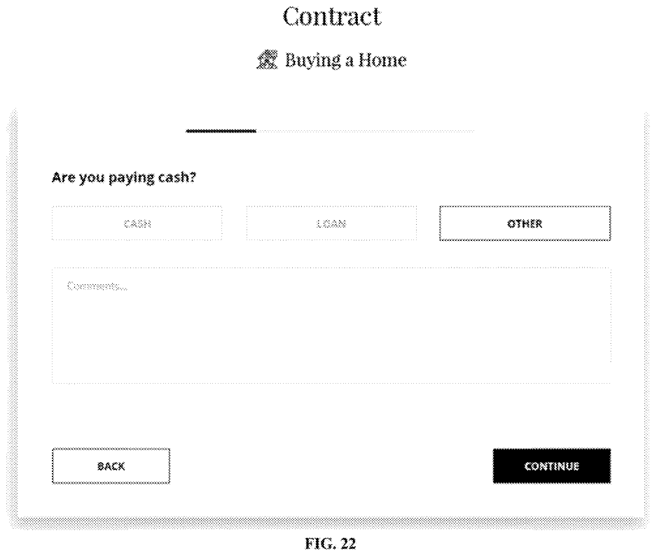

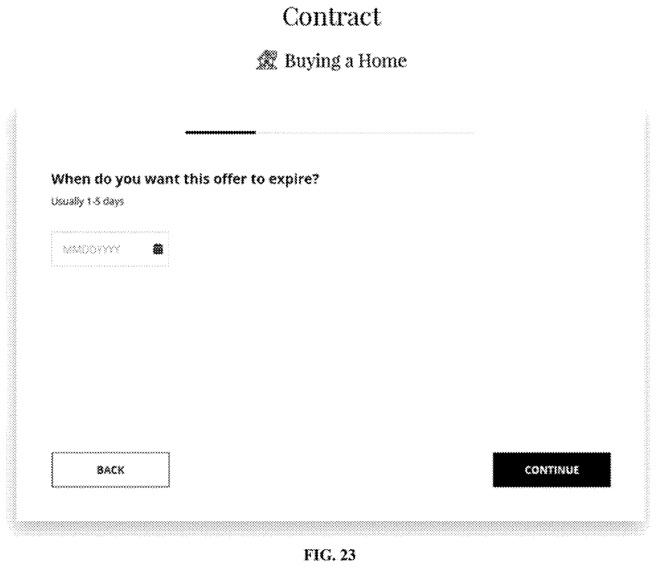

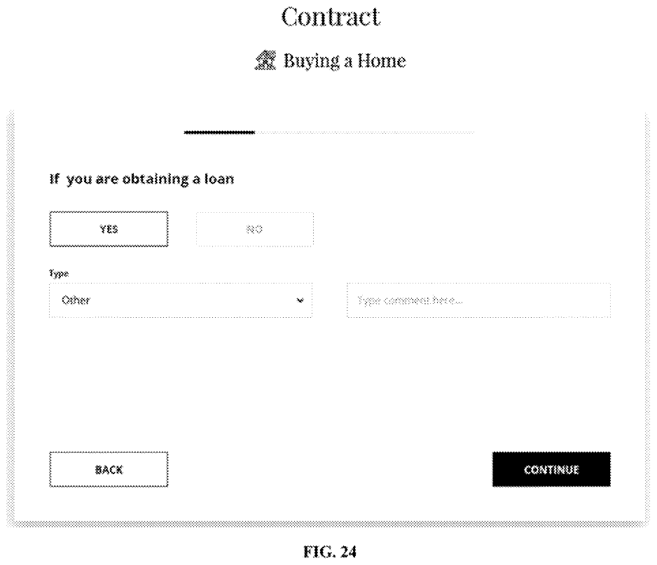

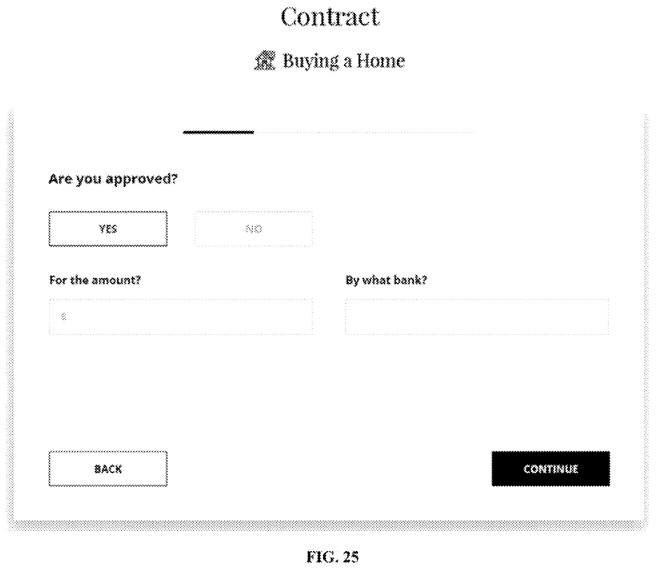

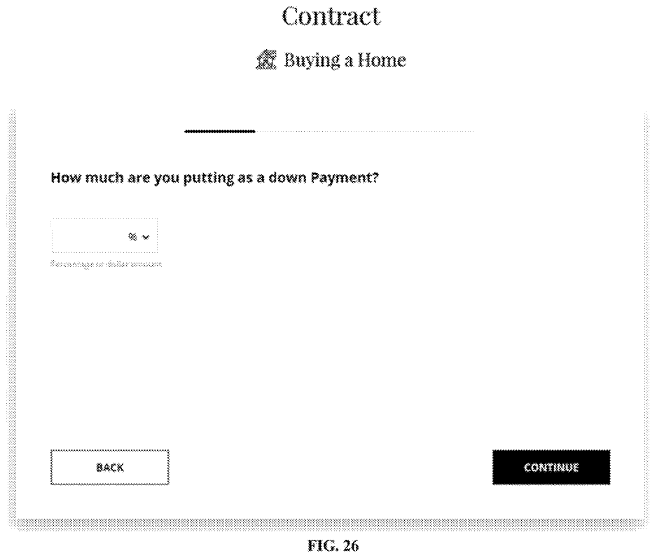

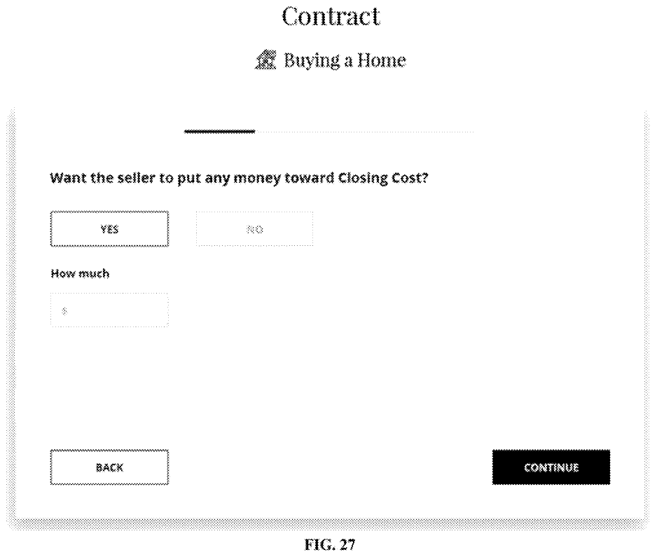

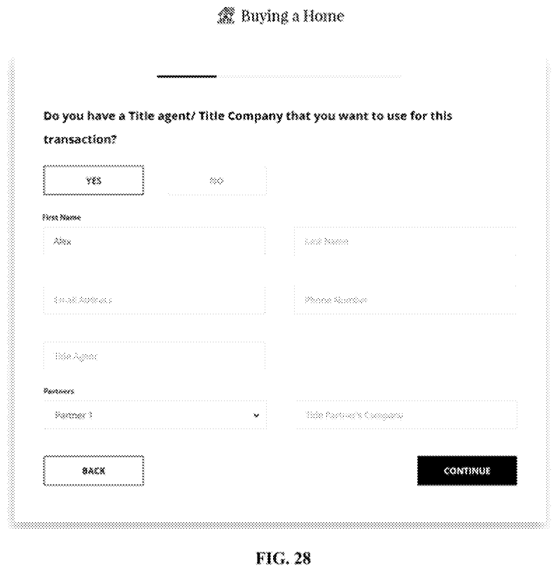

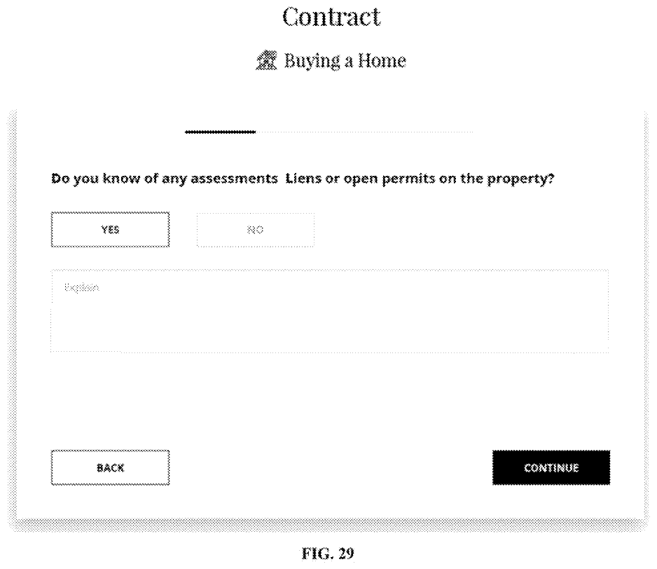

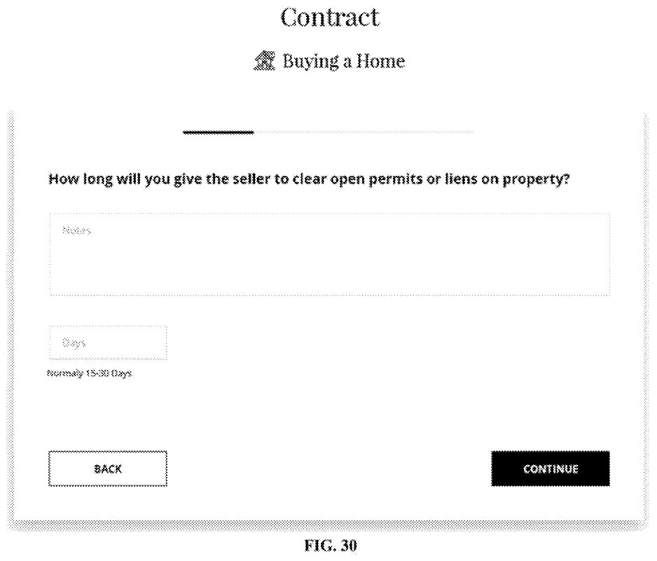

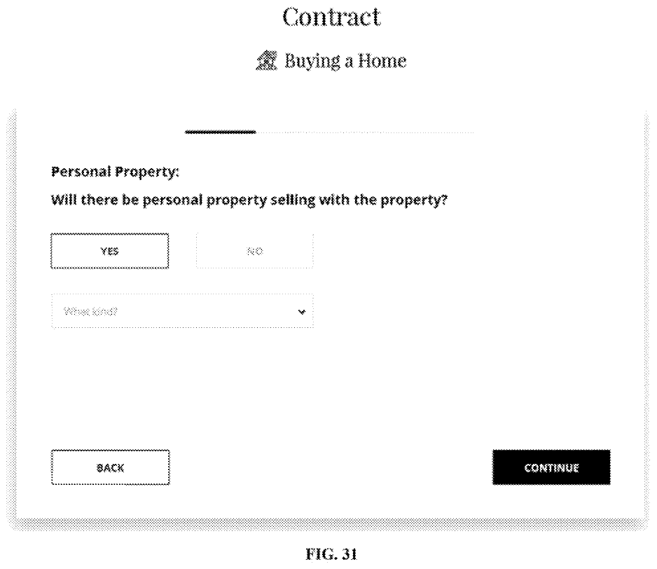

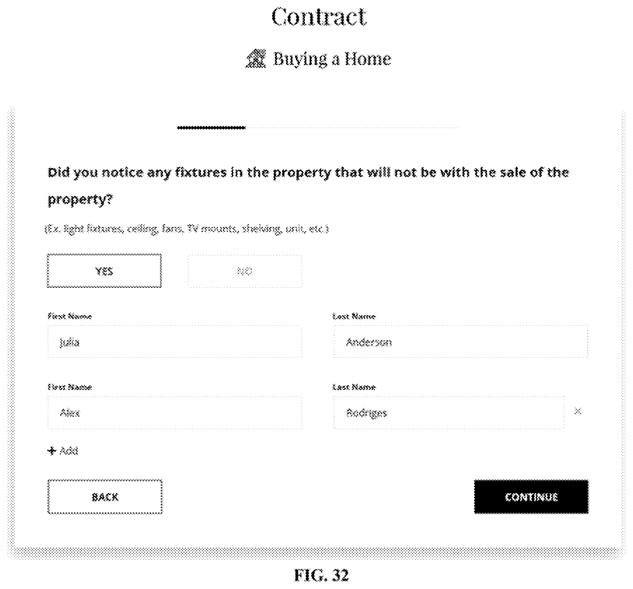

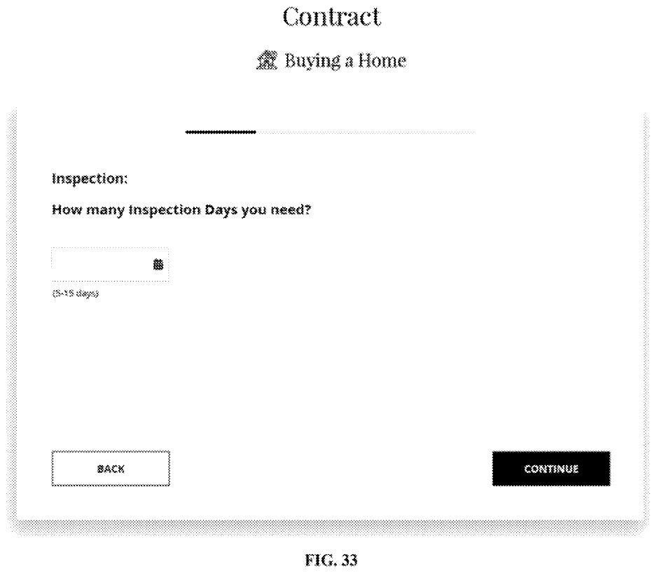

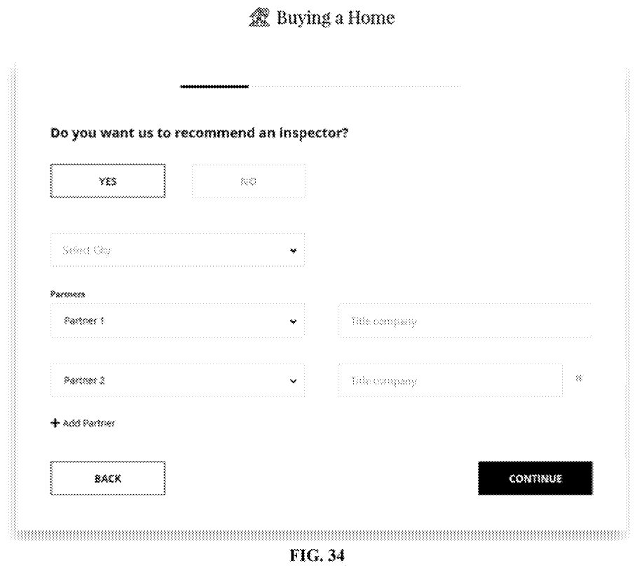

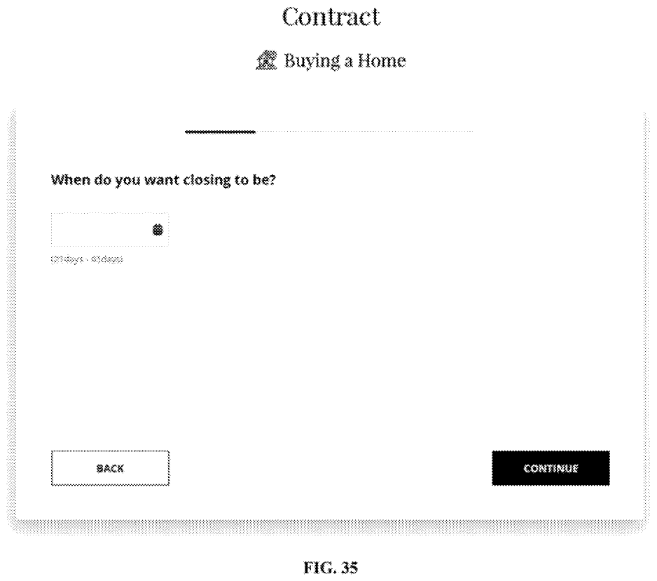

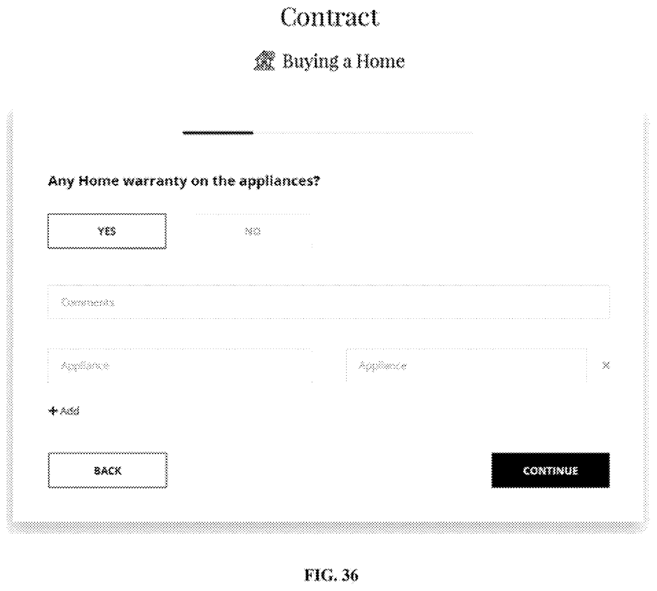

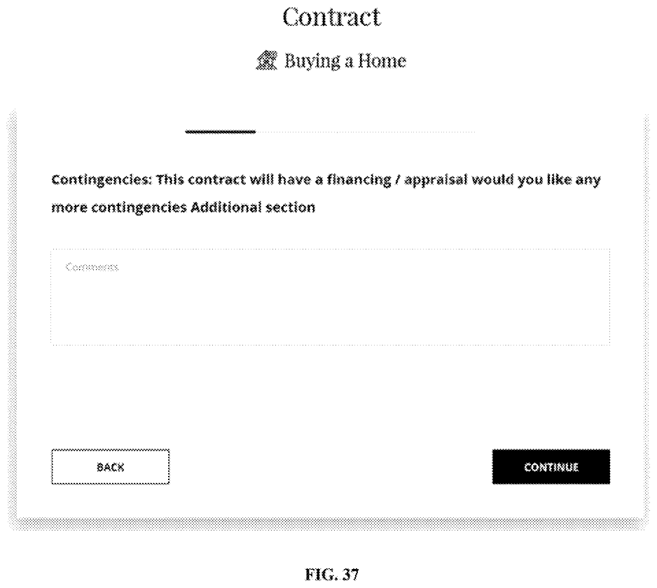

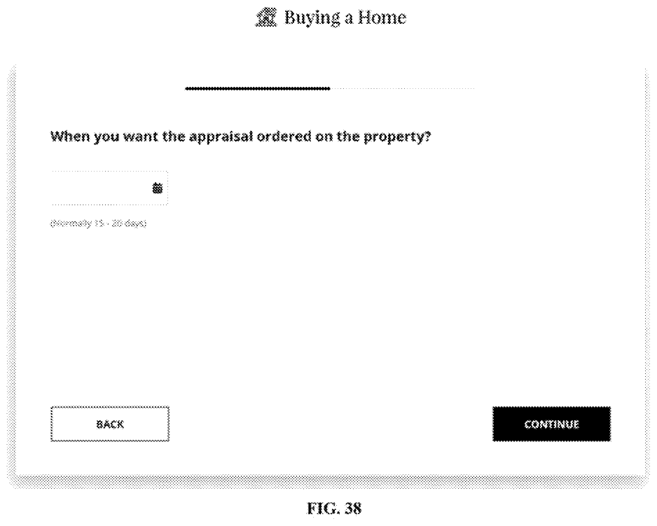

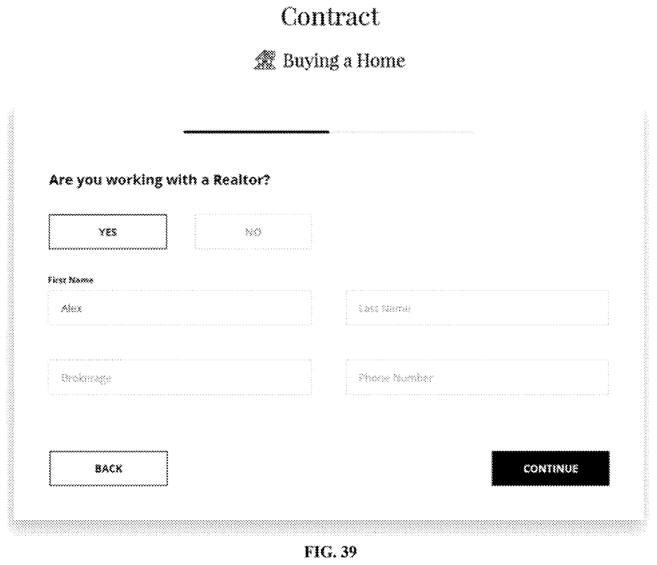

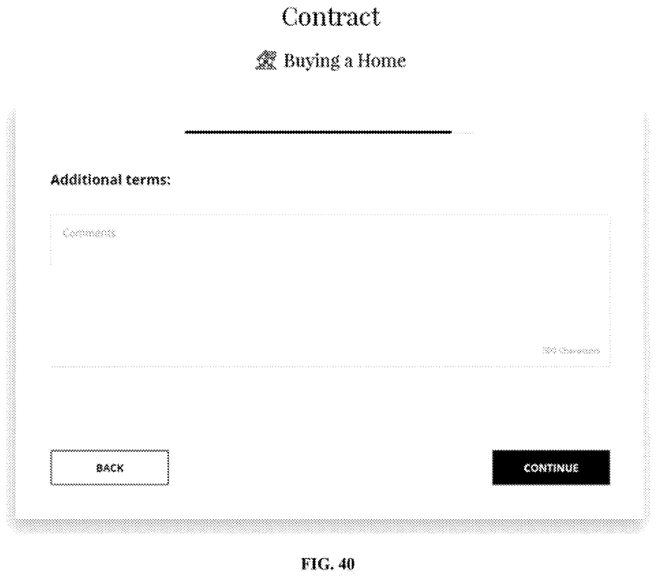

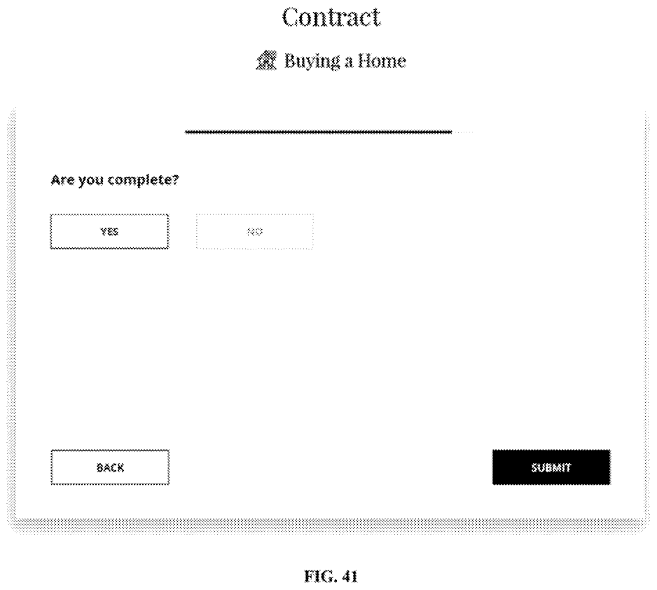

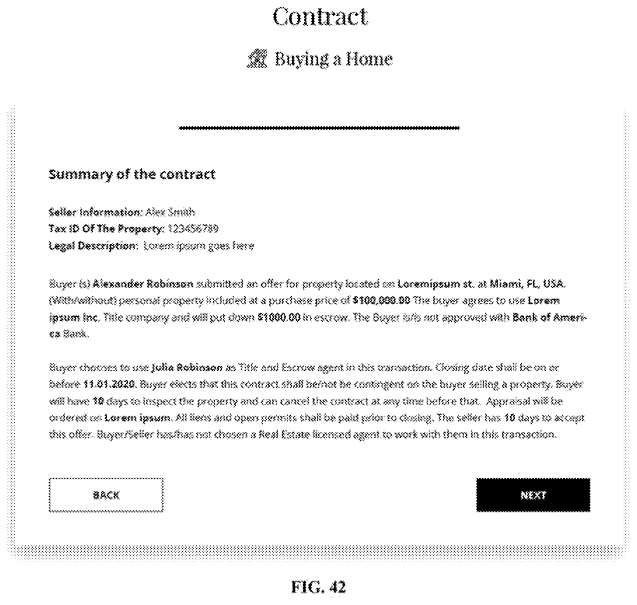

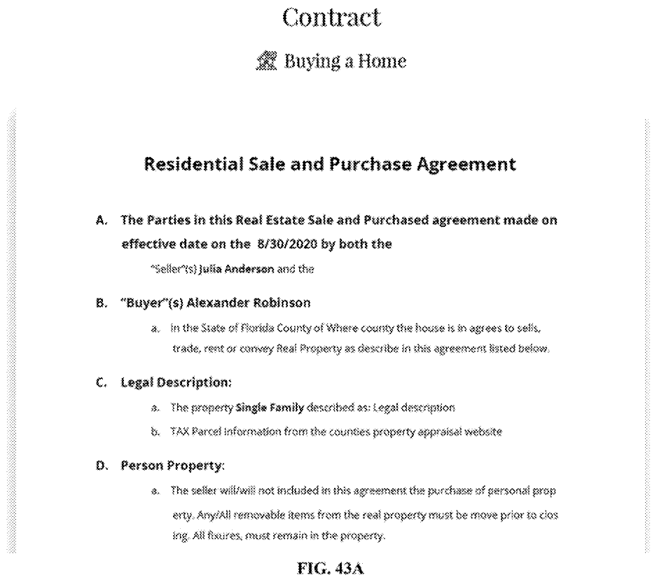

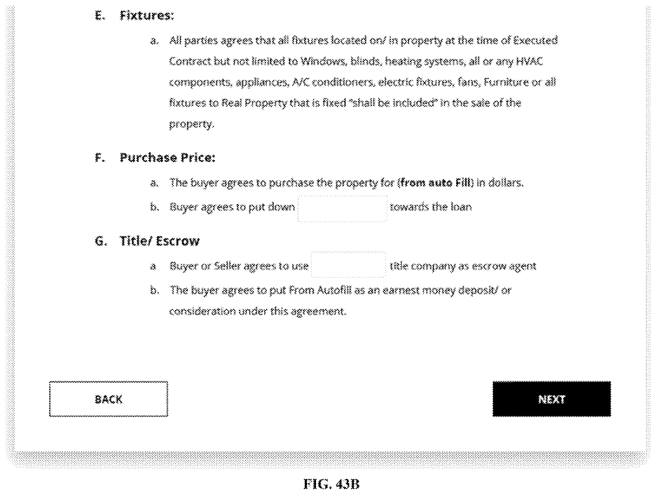

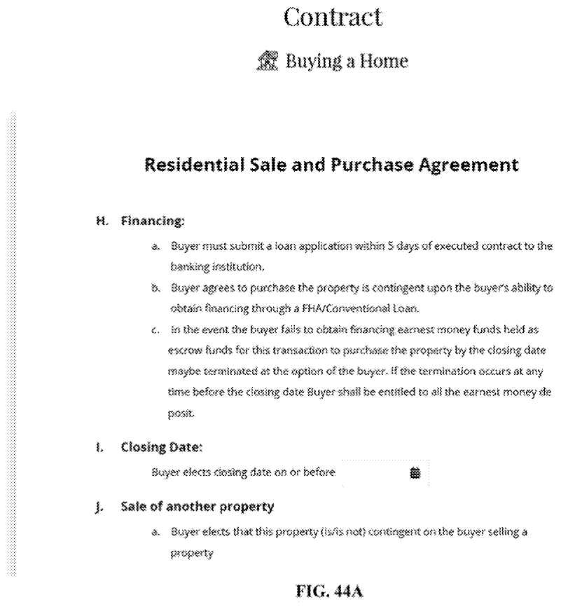

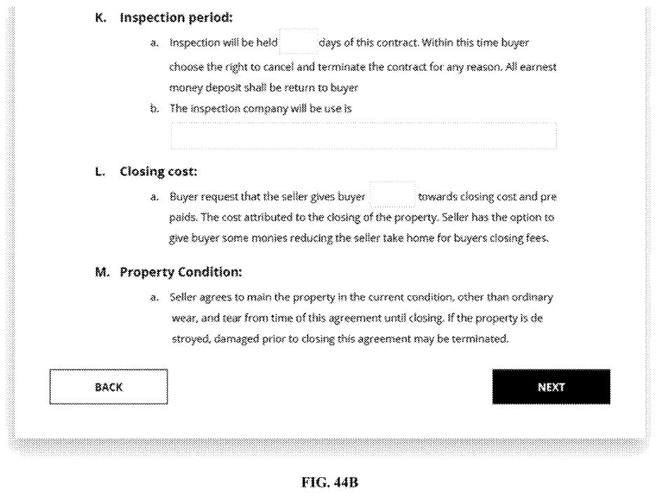

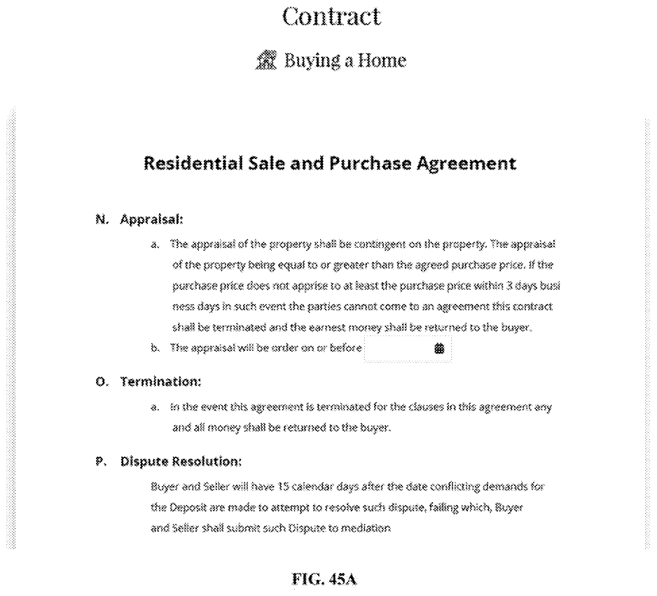

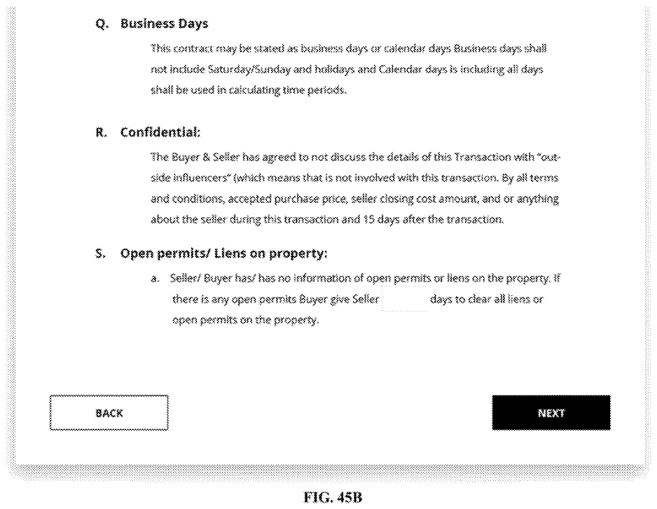

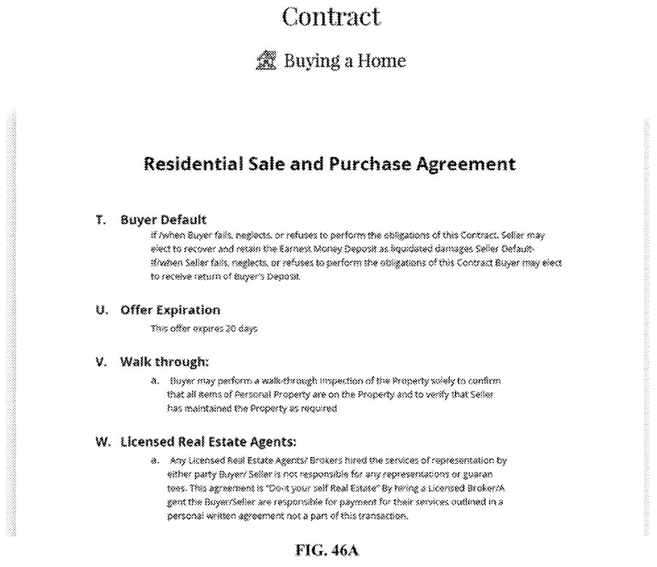

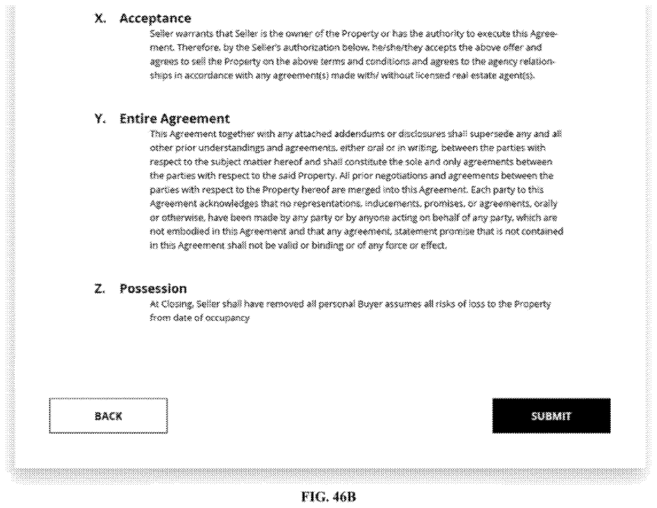

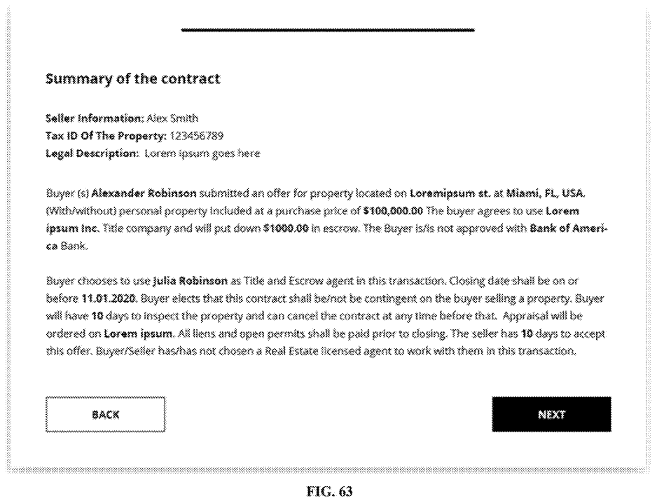

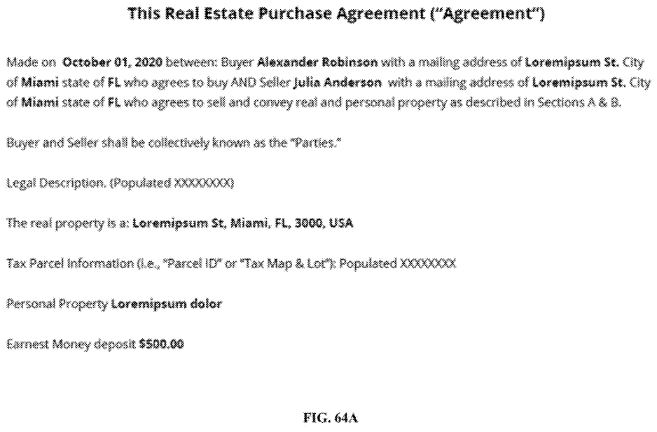

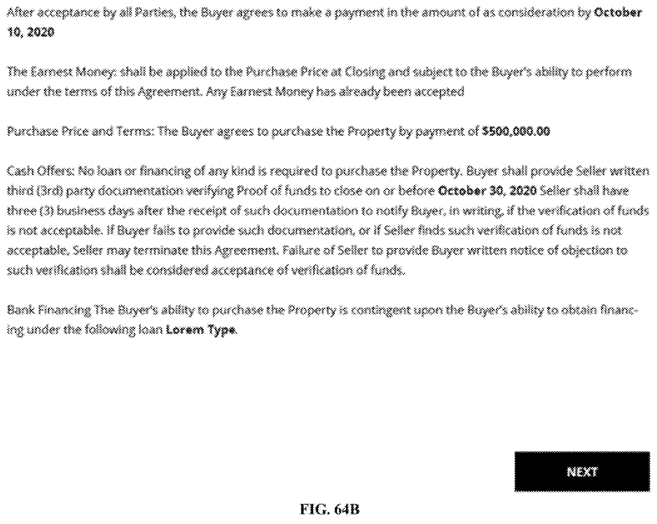

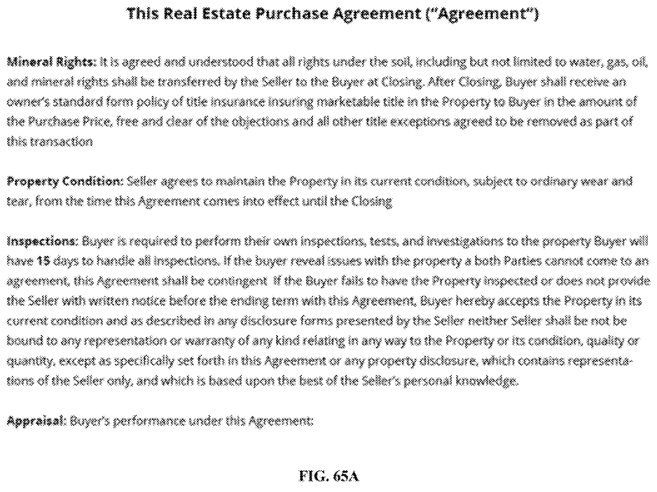

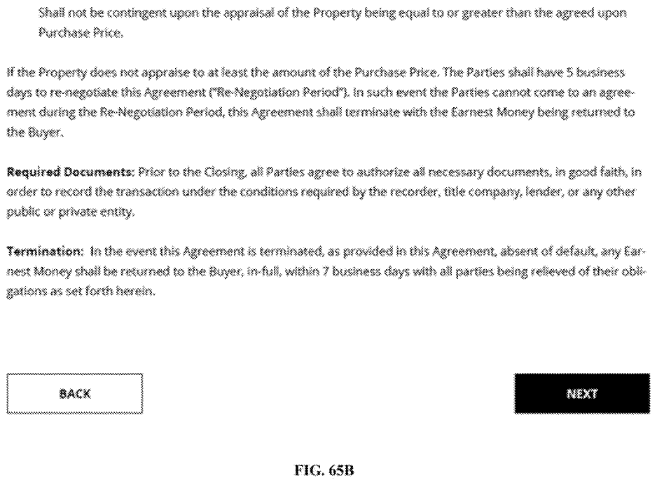

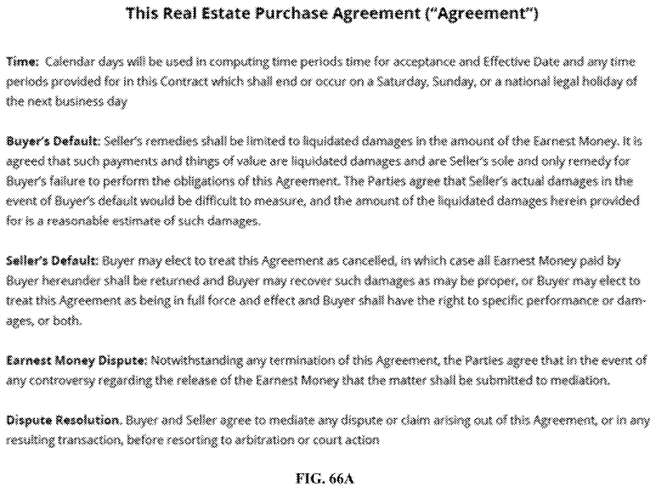

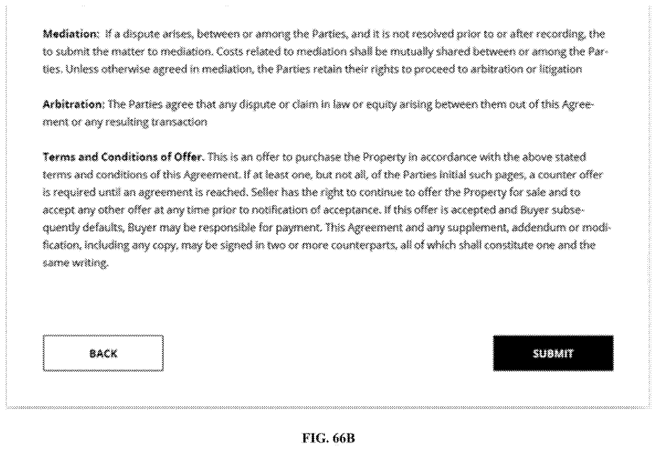

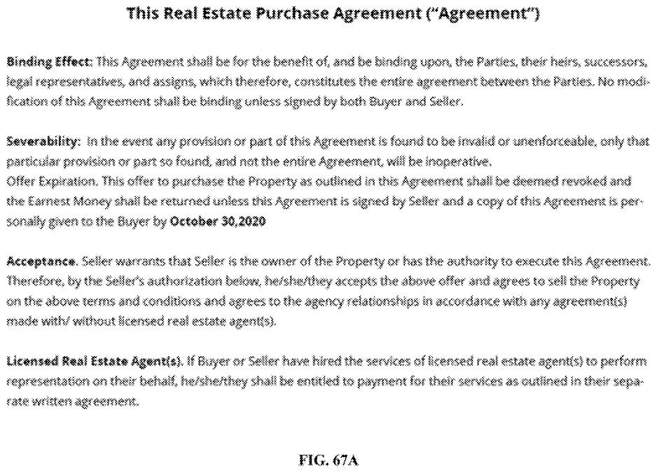

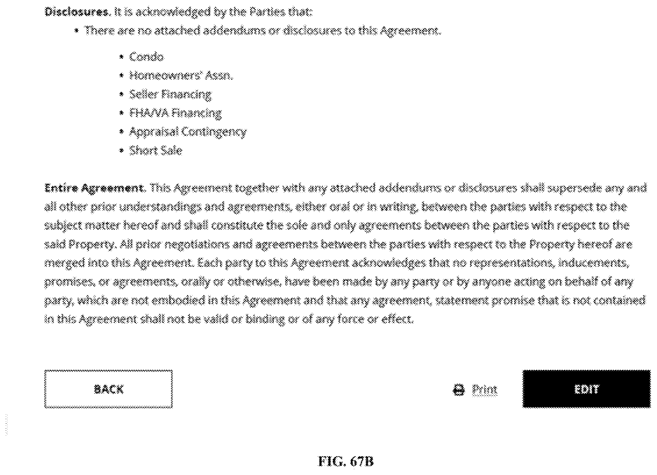

In accordance with a next Step 304, the first user 104a may selectively choose on the first electronic computing device 102a of the first user 104a one of either the “easy” contract formation session or the “do-it-yourself” contract formation session, wherein “easy” is solely used herein for naming purposes and should not be construed otherwise or interpreted in any other matter. As explained above, the “easy” mode poses specific, directed questions to the user 104a, the responses to which are then inserted into the digital real estate contract to form the finalized digital document. This type of contract formation session is preferred for users who are largely unfamiliar with real estate contracts or transactions and are in need of directed and/or assisted guidance with respect to the type of information that must be solicited, gathered, and included in the finalized digital document. FIGS. 11-46 depict the “easy” contract formation session. In contrast, the “do-it-yourself” formation session provides the user 104a with greater flexibility because it grants the user 104a the ability to fill in digital data input fields directly onto the digital document itself until a finalized digital document is achieved. As seen in FIGS. 55-67, the plurality of digital data input fields 1100a-n are contained within the body of the digital document itself. Accordingly, the “do-it-yourself” formation session may be preferable for experts, professionals, or other qualified individuals with experience in the real estate industry.

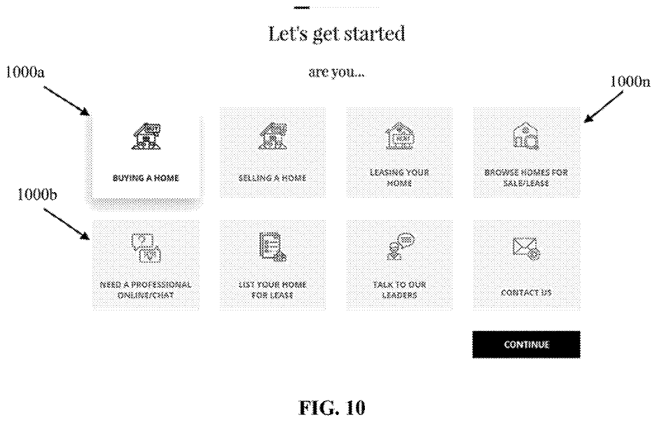

A next Step 305 entails initiating a network-based remote “easy” contract formation session that includes selecting a plurality of GUI icons 1000a-n (as best depicted in FIG. 10) on the electronic display 210 of the first computing device 102a and inputting contract formation data into each of the plurality of digital data input fields 1100a-n. As seen in FIG. 10, the plurality of GUI icons 1000a-n prompt the user 104a to select the type of real estate transaction or contract the user 104a is seeking to prepare or draft. In alternate embodiments, however, the plurality of GUI icons 1000a-n may relate, for example, to a targeted component of the chosen transaction or contract, e.g., type of dwelling, type of financing, etc., and may appear in other steps of the process 300.

Once the user 104a has selected from the plurality of GUI icons 1000a-n and inputted all contract formation data into each of the plurality of digital data input fields 1100a-n, a final Step 306 includes generating a digital document in the network-based remote “easy” contract formation session with a plurality of independent preformed paragraphs each having at least one fillable contract data field disposed therein and assigned and filled in with, using an array data structure, to one of the plurality of digital data input fields to create a finalized digital document without any fillable contract data field therein and that is downloadable to the electronic display of the first computing device 102a. FIGS. 43-46 depict the finalized digital document that is generated at the conclusion of the “easy” contract formation session. In one embodiment, the finalized digital document is downloadable to the first computing device 102a so as to allow the user 104a the ability to readily save a copy of the finalized digital document for the user's personal records and/or for future use or dissemination. In another embodiment, the finalized digital document may be selectively and readily communicatively sharable with, or transferrable from the electronic display of the first computing device 102a to, a second computing device 102n of a second user 104n over the wireless communication network 106, e.g., the agent of the first user 104a or the other contracting party, to facilitate collaborative efforts and improve the speed and convenience of readily sharing the finalized digital document with other users 104a-n. In accordance with an alternate embodiment of the present invention, the finalized digital document may contain fillable contract data field(s) therein to be completed by another user 104b-n, e.g., the seller's agent, after being communicatively shared with the other user 104b-n over the network 106. In this way, the process 300 can be beneficially collaborative, allowing for multiple users 104a-n to contribute to the finalized digital document that is ultimately created. In the “easy” contract formation session, the one or more fillable contract data field(s) is filled in using an array data structure consisting of a collection of elements (i.e., values or variables), each identified by at least one array index or key. The array is then stored such that the position of each element can be computed from its index tuple by a mathematical formula. The array data structure may be one-dimensional or multidimensional.

In one embodiment, the first electronic computing device 102a of the first user 104a is geographically located at a different physical building location than the computer server 108. This feature beneficially allows the process 300 to be ran at various remote locations by the plurality of users 104a-n. Particularly where the plurality of users 104a-n seek to collaborate on any given real estate contract, this feature facilitates this collaboration as none of the users 104a-n are required to simultaneously be in a shared geographic location with each other or with the server 108 in order to perform the process 300.

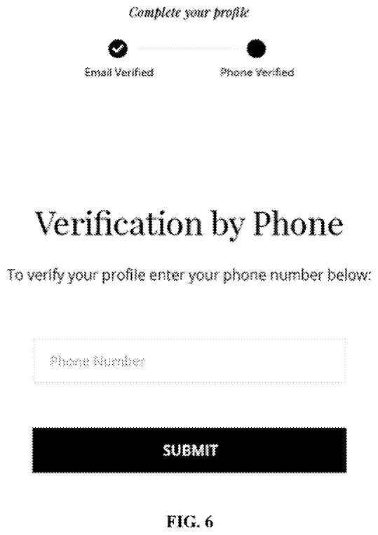

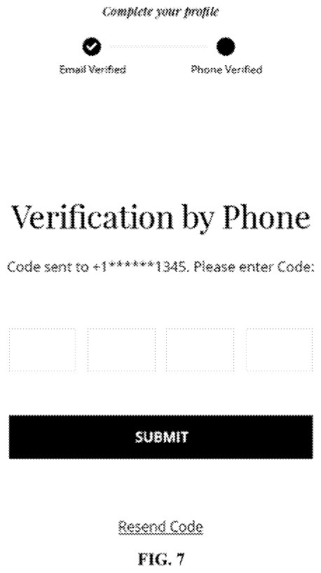

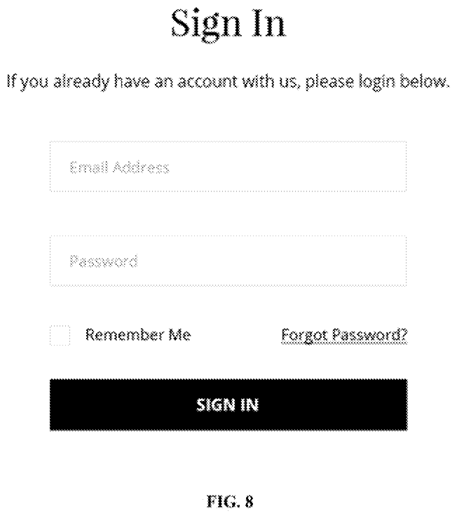

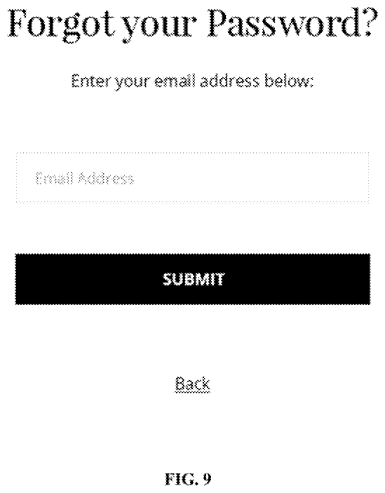

The process 300 may further include the Step of communicatively coupling the first electronic computing device 102a of the first user 104a to the computer server 108 over the wireless communication network 106 and registering into a user account resident on the computer server 108 before generating the digital GUI 202 on the electronic display 210 of the first computing device 102a. Beneficially, this feature allows the user 104a to partially or fully complete a real estate contract through the “easy” contract formation session or the “do-it-yourself” contract formation session and save the user's progress so the user 104a may return to the digital contract at a later time, e.g., to complete, edit, revise, view, or share the digital contract over the network 106 at a later time. Said differently, the user account associated with the user 104a may contain all of the digital contracts prepared and saved by the user 104a. FIGS. 4-9 depict the steps associated with creating and retrieving user accounts. As seen in FIG. 4, the user 104a may be required to input select identifiable personal information, e.g., first and last name, email address, phone number, password, etc., to enable the server 108 to link the user 104a with a specific user account. The process 300 may include additional steps to verify the user account of a user 104a such as, by way of example and without limitation, verifying the email (FIG. 5) or phone number (FIGS. 6-7) of the user 104a by sending a one-time passcode to the user's email or phone number which the user 104a would then need to input to verify their identity and be granted access to the user account. To be granted access to the user account thereafter, the log-in credentials that correspond to the user's user account must be inputted (as depicted in FIG. 8). In the event the user 104a forgets their log-in credentials, there may be a method of retrieving said credentials or verifying the user's identity and resetting the credentials, e.g., by sending a verification code to the email address or phone number originally provided by the user 104a (as seen in FIG. 9).

Referring now to FIG. 49, the process 300 may further comprise a digital informational icon 4900 disposed proximal to (wherein “proximal to” is defined herein as at or near) each of the plurality of digital data input fields 1100a-n and having informational text included therein; and displaying the informational text on the electronic display of the first computing device 102a upon selectively modulating the digital informational icon 4900. In an exemplary embodiment, the informational text that accompanies the digital informational icon 4900 offers descriptive, explanatory, and/or guiding text intended to better inform the user 104a of the type of information sought by the digital data input field 1100a associated with that particular digital informational icon 4900. In one embodiment, the informational text visually appears only when the user 104a selectively modulates, e.g., hovers over, selects, or clicks on, the digital informational icon 4900. This feature controls the amount of informational text the user 104a is exposed to at any given time so as to make each Step of the process 300 easier to understand and complete for the user 104a. In other words, this feature beneficially prevents the user 104a from being inundated with superfluous informational text that is pertinent at a later Step in the process 300, e.g., for a subsequent digital data input field 1100b, but that is not directly relevant to the digital data input field 1100a the user 104a is completing at that given moment. Likewise, a plurality of independent and sequentially viewable windows within the network-based remote “do-it-yourself” contract formation session may collectively form part of the digital document with the plurality of GUI icons on the electronic display of the first computing device 102a.

For this same beneficial purpose, namely, to aid the user 104a in understanding, organizing, and completing the process 300, the process 300 may also include a plurality of independent and sequentially viewable windows within the network-based remote “easy” contract formation session that collectively form part of selecting the plurality of GUI icons on the electronic display of the first computing device 102a and the inputting contract formation data into each of the plurality of digital data input fields 1100a-n, the plurality of independent and sequentially viewable windows generating before generation of the digital document in the network-based remote “easy” contract formation session with the plurality of independent preformed paragraphs. In this way, the plurality of digital data input fields 1100a-n are broken up into smaller parts reflected in a plurality of independent and sequentially viewable windows to make the process 300 easier, quicker, and simpler to perform.

In lieu of the network-based remote “easy” contract formation session, the user 104a may initiate the network-based remote “do-it-yourself” contract formation session that includes generating a digital document with a plurality of GUI icons on the electronic display of the first computing device 102a, with a plurality of independent preformed paragraphs each having one or more digital data input field(s) 1100a therein, and filling in the one or more digital data input field(s) 1100a to create a finalized digital document without any fillable contract data field therein and that is downloadable to the electronic display of the first computing device 102a. As such, Step 305 may comprise the foregoing as part of the network-based remote “do-it-yourself” contract formation session as opposed to initiating a network-based remote easy contract formation session that includes selecting a plurality of GUI icons on the electronic display of the first computing device 102a and inputting contract formation data into each of the plurality of digital data input fields as part of the “easy” contract formation session. Based on the needs and preferences of the user 104a, the type of contract formation session, i.e., the “easy” or “do-it-yourself” sessions, may be selectively modified by the user 104a. Said differently, the user 104a may switch from the “easy” contract formation session to the “do-it-yourself” contract formation session, and vice versa, as needed or desired. This feature is particularly beneficial where the needs or expertise of the user 104a vary from real estate transaction to real estate transaction, e.g., the user 104a may be very familiar with the sale of residential dwellings and therefore desire the “do-it-yourself” contract formation session but may be largely inexperienced or unfamiliar with the sale of commercial buildings and therefore stand to benefit more from the “easy” contract formation session in that circumstance.

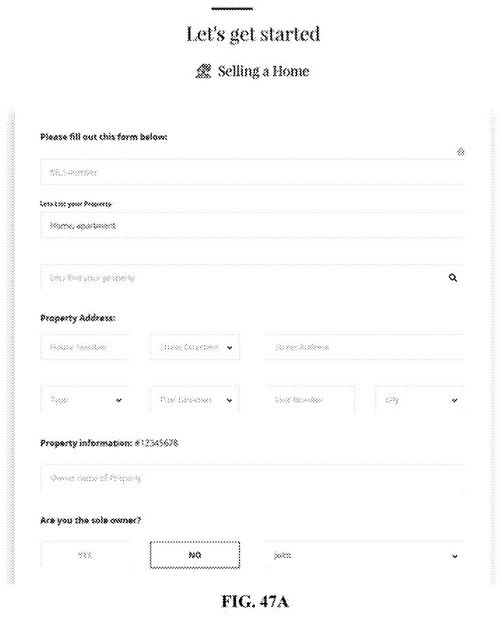

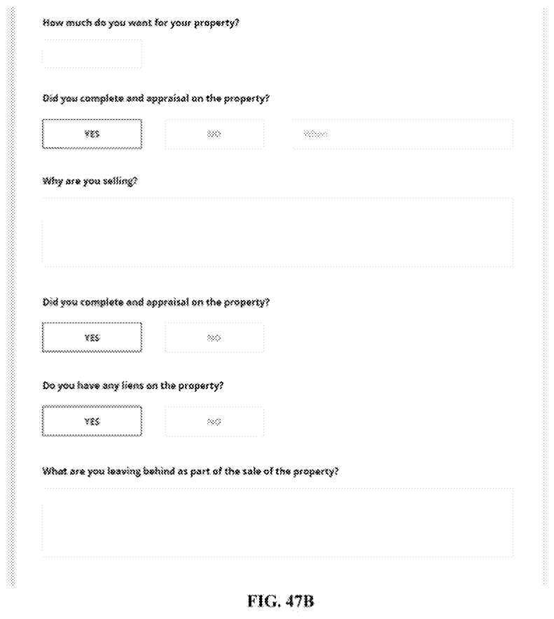

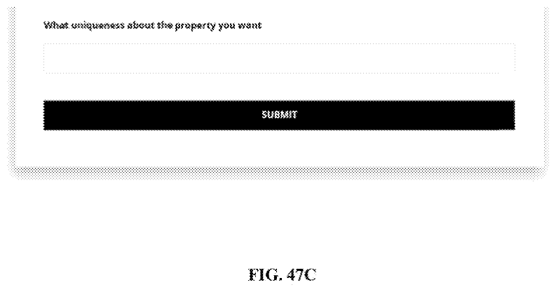

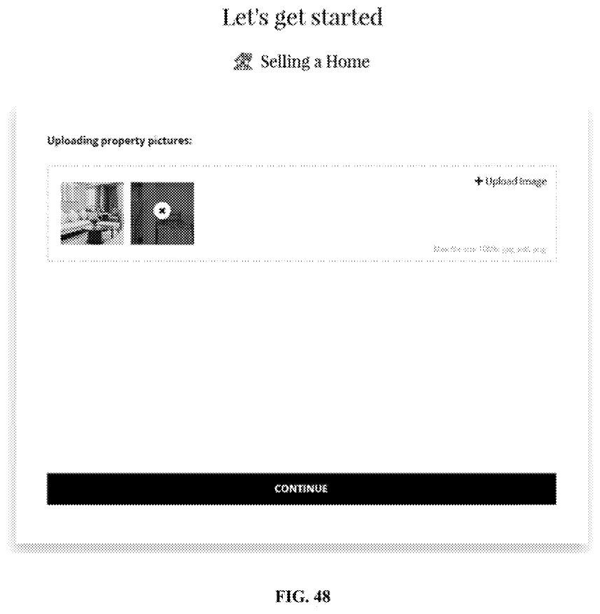

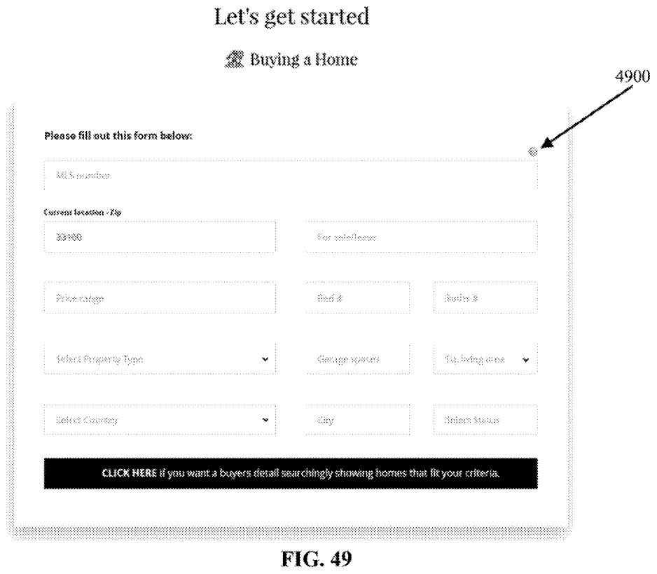

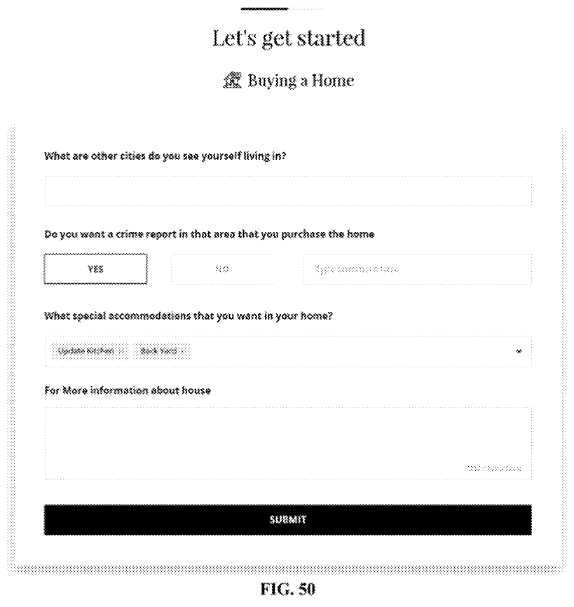

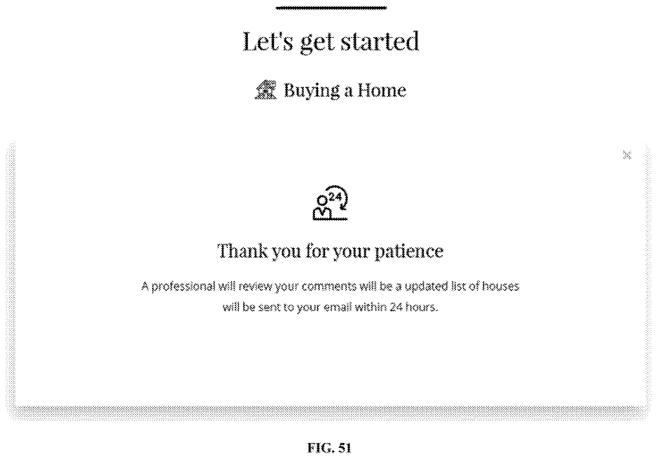

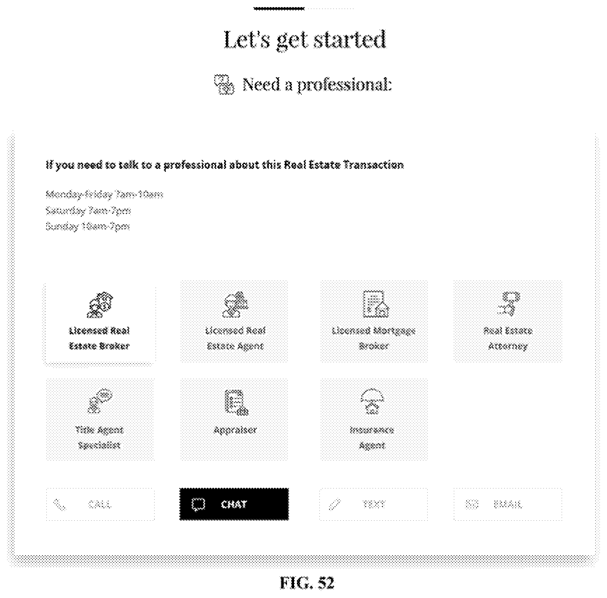

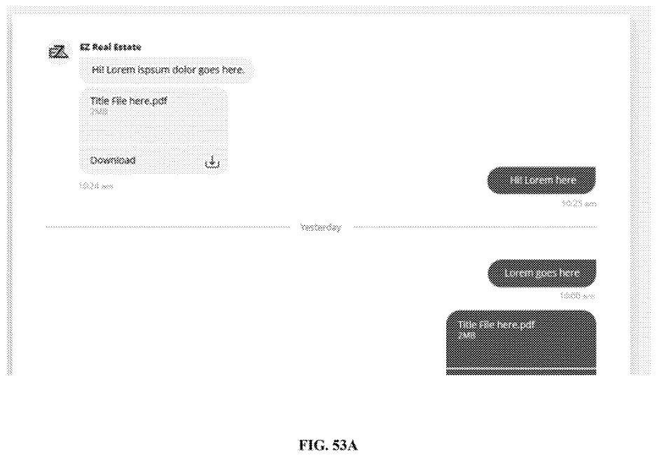

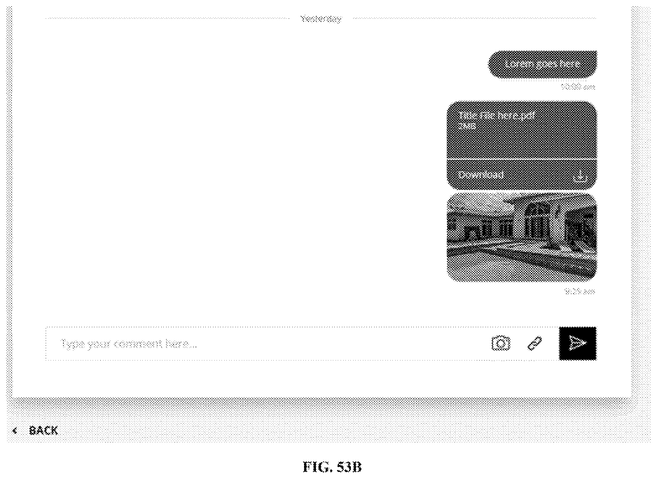

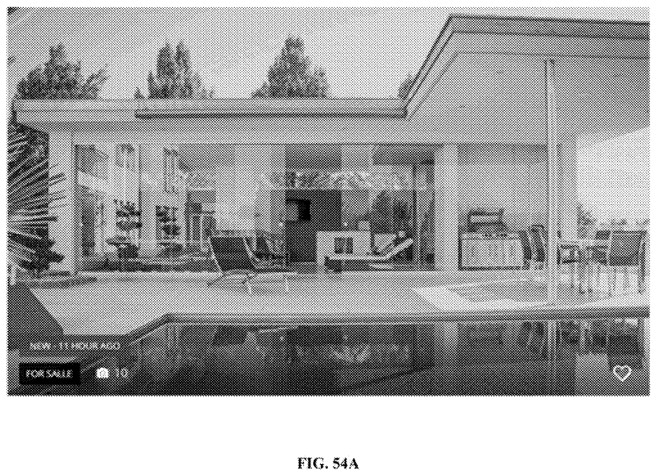

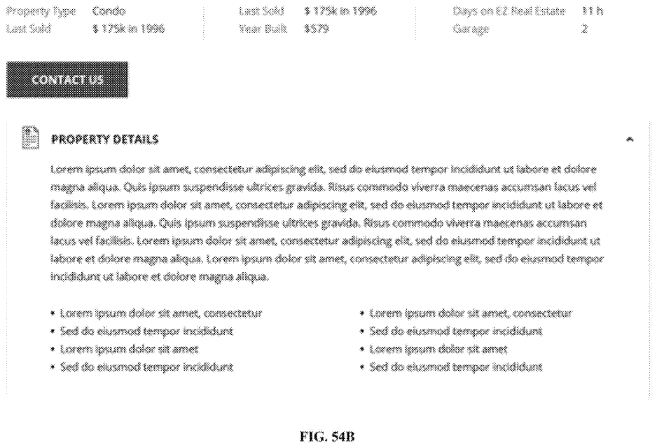

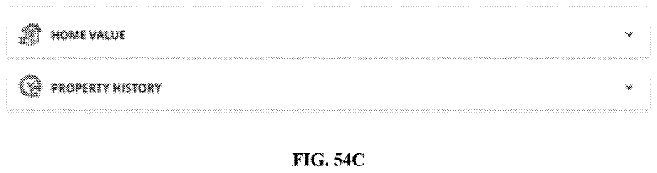

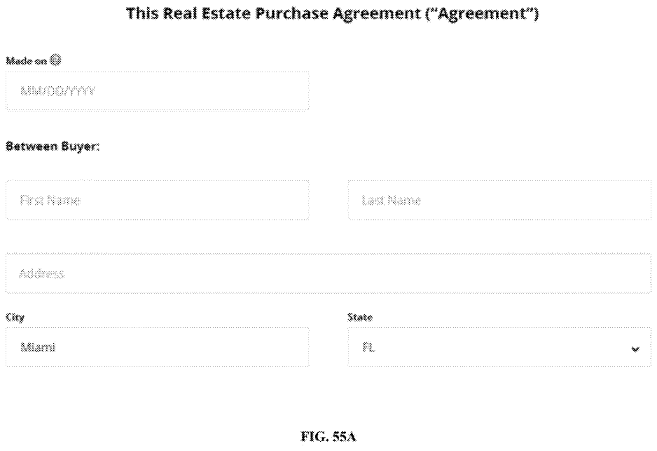

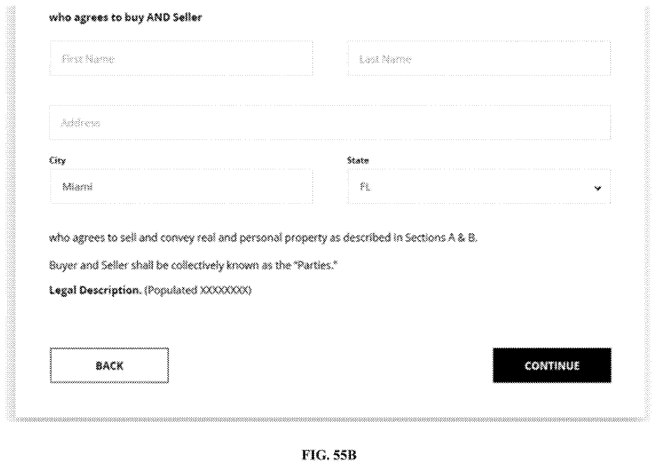

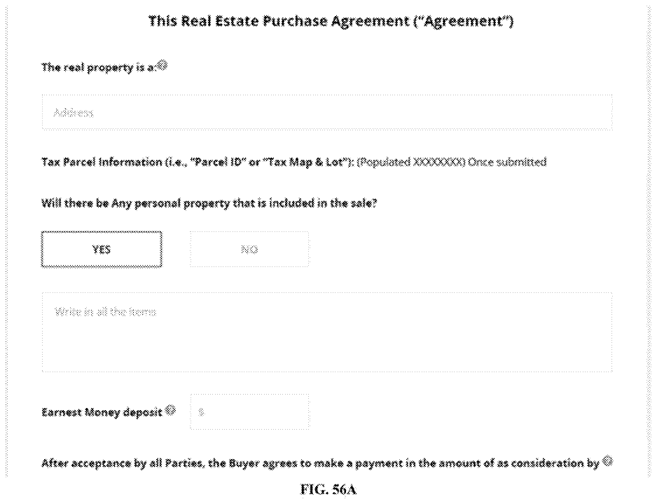

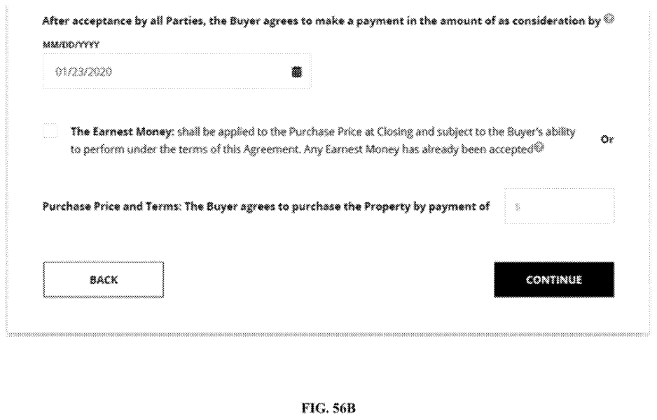

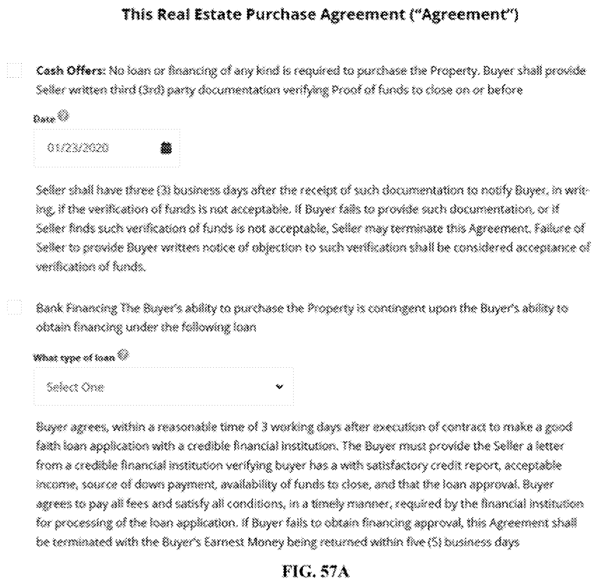

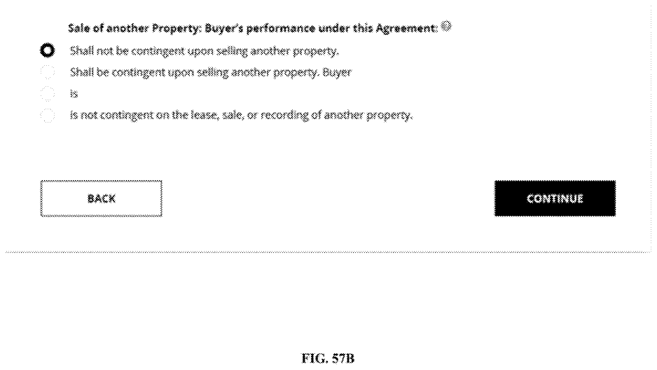

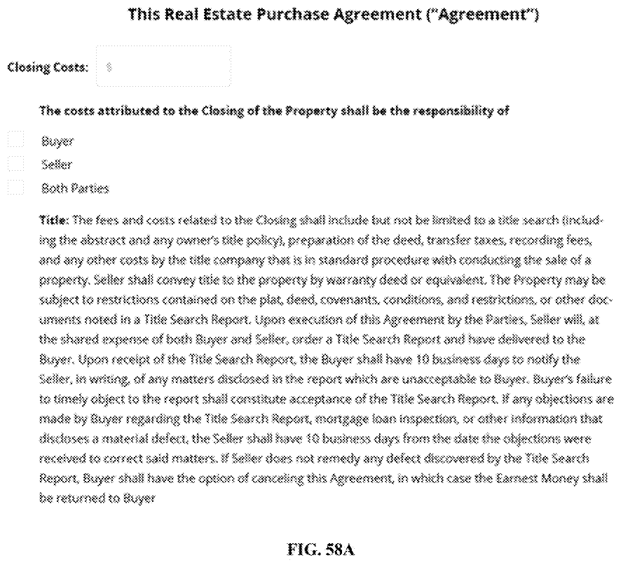

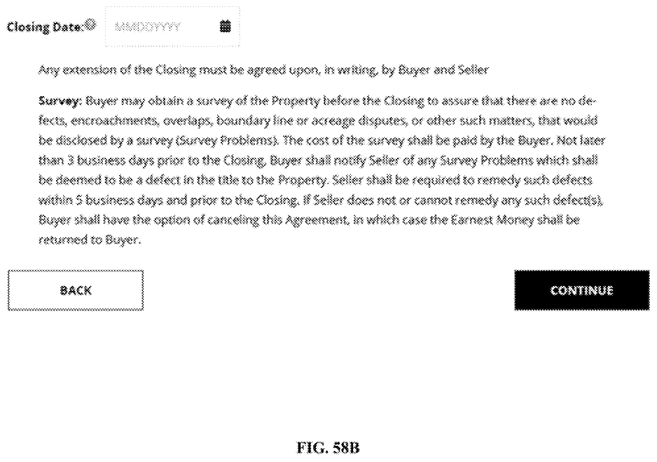

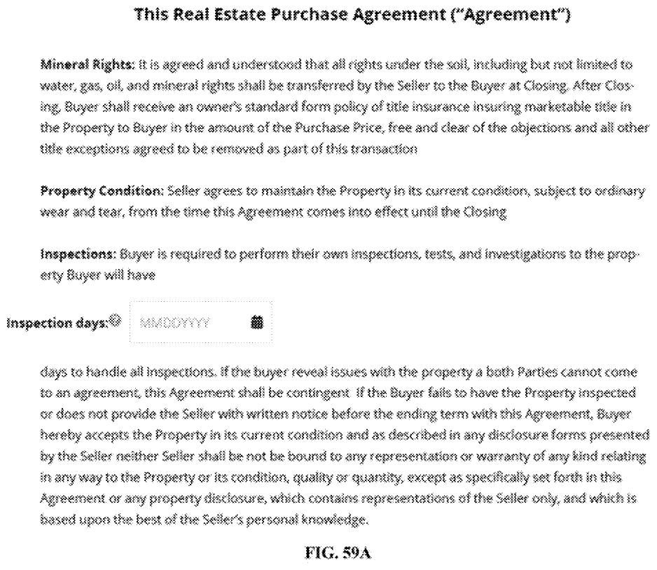

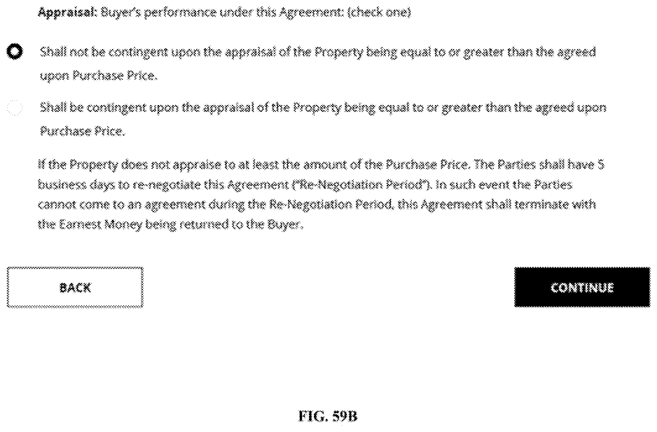

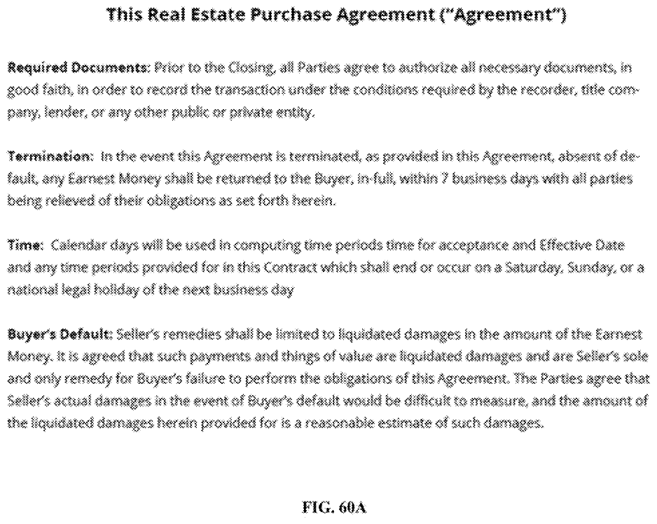

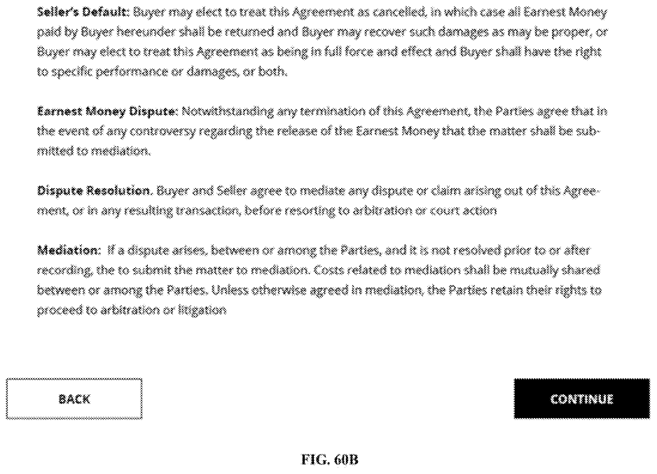

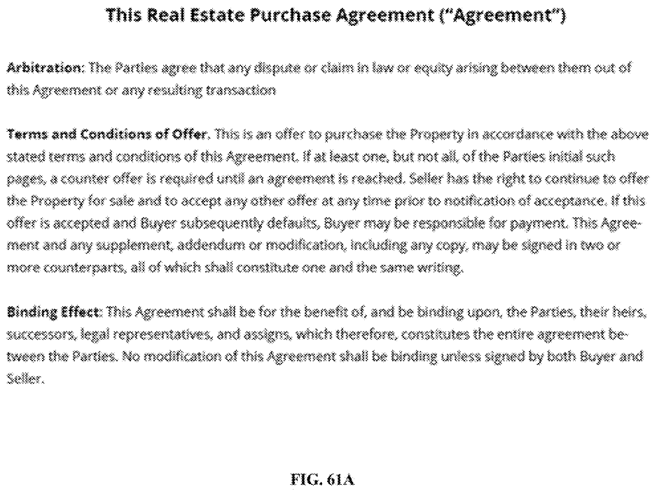

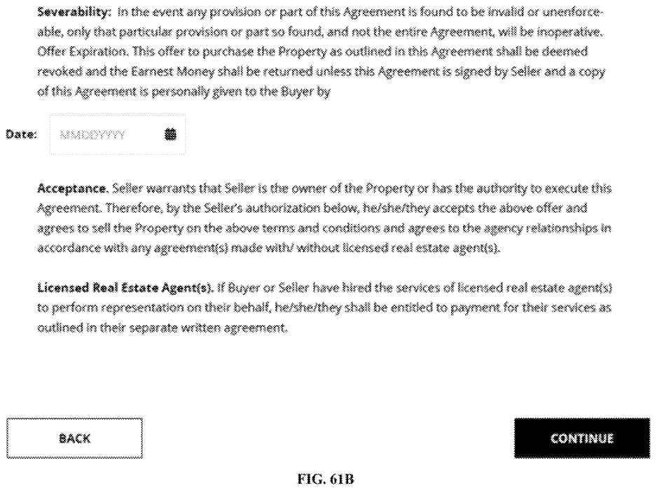

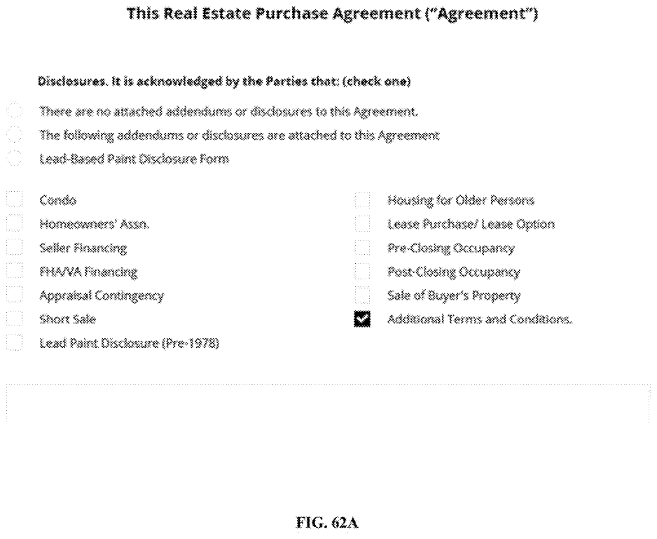

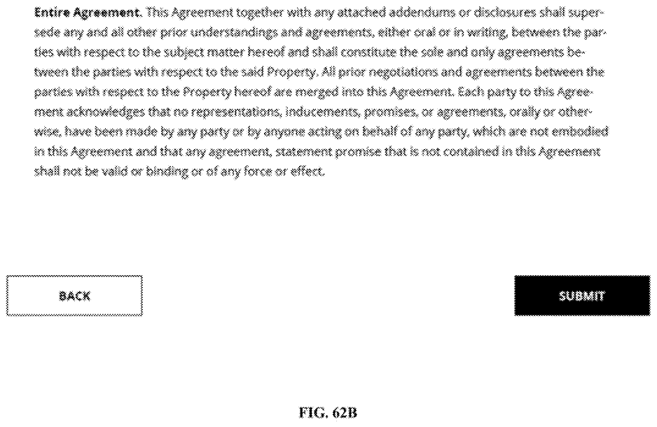

As demonstrated in FIGS. 47-54, the process 300 may also allow the user 104a to perform additional actions associated with or related to real estate, e.g., listing a property for sale (as depicted in FIGS. 47-48), requesting a professional list of properties available for purchase that fit the user's inputted criteria (as seen in FIGS. 49-51), submitting a request for a consultation with a real estate professional such as a licensed real estate broker, a licensed real estate agent, a licensed mortgage broker, a real estate attorney, a title agent specialist, an appraiser, or an insurance agent (as seen in FIG. 52), communicating with a real estate professional over the network 106 (as depicted in FIG. 53), and publishing, browsing, and reviewing property listings (as seen in FIG. 54).

In another embodiment of the present invention, a software-based and coded artificial intelligence (AI) tool is employed that may carry out one or more portions of the computer-implemented and interactive real estate contract generation and editing process. More specifically, the process may be generalized and formed into three steps. The first step, i.e., an “inquisitive analysis” step may include asking pertinent contract formation questions to gather all the necessary information for the contract to be formed or reviewed. The first step may include an AI tool that is operably configured to identify key details (e.g., words, phrases, numbers, and other alpha-numeric text) inserted by the first user or a second user, or simply readable from a contract uploaded by a user, thereby ensuring a comprehensive understanding of the contract requirements. The second step, or an “intelligent summarization” step, may including utilizing an AI tool with an algorithm configured to condense a contract's written content or a user's inputted contract formation data into a concise and easily digestible format, e.g., through displaying said contract's written content as part of the one or more contract formation text within the plurality of independent and sequentially viewable windows. This second step enables swift comprehension and saves valuable time for all parties/user involved. The third step, i.e., “streamlined contract formulation” step, may include generating or formulating a legal contract by utilizing the pertinent extracted information and summarized content. As such, the contract formation process has been automated with AI, eliminates human error, and expedites the creation of accurate and legally sound agreements. Stated even further, the process integrates the AI tool into the contract management process to navigate the complexities rear estate contracts and other contractual agreements with utmost efficiency and precision. The summarization process referenced above is also operable to connect sentences from the data entered in the inquiry phase and can be interrupted in the language of the user to understand the meaning of summarization. Once a user receives a contract, the system and process are also configured to promptly acknowledge its arrival and then may proceed to simplify the contract using everyday common language, making it easier for the user to understand. Additionally, the system allows the user to input any counter terms they may have.

The process may begin and immediately proceed to the step of providing a first electronic computing device of a first user and having an electronic display configured to display a digital graphical user interface (GUI) and a computer server (as exemplified in FIG. 1). Next, the process includes communicatively coupling the first electronic computing device of the first user to the computer server over a wireless communication network (also exemplified in FIG. 1). Next, the process may include initiating a network-based remote easy contract formation session having multiple ancillary steps (that may be executed locally on the first user's 104a electronic device 102a).

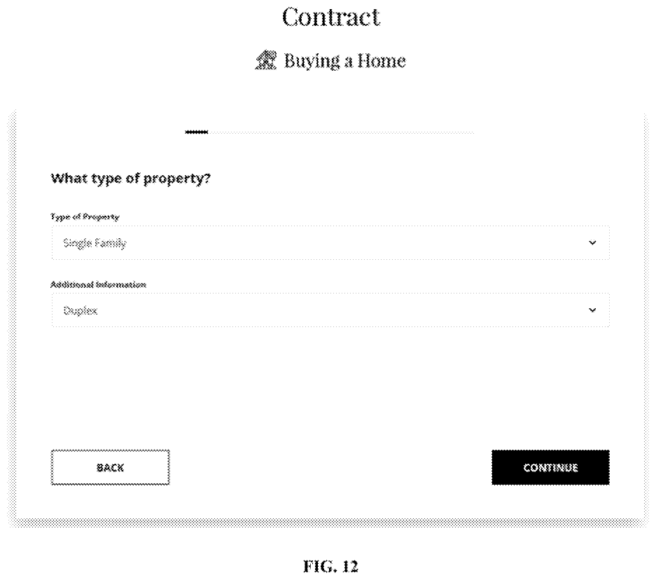

One such ancillary step includes generating a plurality of independent and sequentially viewable windows on the GUI of the electronic display of the first electronic computing device, wherein each of the independent and sequentially viewable windows display one or more contract formation text therein (e.g., “what type of property” is being bought-see, e.g., FIG. 12) and at least one digital data input field (see, e.g., FIG. 12). Another exemplary ancillary step includes receiving alpha-numeric text corresponding to contract formation data within each of the plurality of digital data input fields from the first user (see, e.g., FIG. 12).

Beneficially, another exemplary ancillary step includes executing a software-based learning tool (locally on the first user's device 102a or on the server 108) that is programmed to ascertain and ascertains the contract formation data, in addition to comparing said contract formation data to a learning data structure to ascertain a match corresponding to a user understanding of the at least one contract formation text associated with each of the independent and sequentially viewable windows. Said another way, the software-based learning tool may ascertain and review input in response to the “type of property” that is being bought and if the user inserts $200,000, the software-based learning tool is require the first user to re-insert new contract formation data and/or rephrase and/or re-display the at least one contract formation text to ensure the first user (or other users, if applicable) understands the inquiry. The software-based learning tool is capable of learning in that it may autonomously update the learning data structure with the user inputted “non-matched” text if inserted in a predetermined and programed number of different network-based remote easy contract formation sessions, agreed to be two or more different users, etc. A “match” may include, but not necessarily limited to, the identical wording of the contract formation data when compared to the programmed in the learning data structure (which may be stored resident on the server 108 for speed and efficiency in the formation process).

Thereafter, another exemplary ancillary step may include generating, after completion of the plurality of independent and sequentially viewable windows and at a conclusion of the network-based remote easy contract formation session, a digital document with a plurality of independent paragraphs each having at least one fillable contract data field disposed therein and assigned to and filled in with at a portion of software-defined and software-selected contract formation data using the software-based learning tool to create a finalized digital document without any fillable contract data field therein. Said differently, the software-based learning tool is programmed select all or a portion of the contract formation data such that it makes sense (based on a programmed or learned data structure) of the contract formation data within the overall and surrounding text of the written contract. To that end, the AI tool may be programmed to rewrite sentences, portions of sentences, words, or paragraphs of the digital document to ensure clarity of the contract. Stated further, the software-based learning tool may be, as described above, programmed to ascertain and ascertains the contract formation data and compares said contract formation data to a learning data structure to ascertain a match or a close-match (having common misspellings of certain words commonly used in response to an inquiry).

In further embodiments of the present invention, the process may includes, in particular within steps 305, 306, 307 depicted in FIG. 3, an artificial intelligence (AI) module specially programmed to utilize data associated with the real estate transaction, namely the real estate property listing data that includes the proper location, market trends, and historical data for the property and other geographically and structurally similar properties. This data may be stored in a repository communicatively coupled to the AI module. Based on this analysis, the AI module is operably configured to provide users with recommendations for the best offer or pricing strategy in the contract, which is particularly helpful in the “do it yourself” mode. Moreover, the AI module is communicatively coupled to one or more (preferably a plurality) of Internet retrievable data sources having information on timing of sales of properties (e.g., from contract to close) properties in the area are being sold, e.g., helping user gauge whether to adopt an aggressive pricing strategy or a more conservative one.

Said another way, the AI module is operably configured to determine how long similar properties (e.g., having the same room/bath and/or square footage and/or roof age metrics) that have been on the market, suggesting adjustments to the offer if a property has been listed for an extended period. In one embodiment, as users fill out the contract, the AI module contextual suggestions based on the section they are working on. For example, if users are in the “financing” section, the AI module can suggest common financing options based on property type and location. Utilizing listing remarks, the AI module is operably configured to highlight potential upgrades or features that could enhance the property's value, guiding users on how to articulate these features in the contract. Moreover, the process may include the AI module being operable configured to interact with users in real time, wherein users can ask the written or verbal questions that are received by the AI module and are related to specific clauses or terms, receiving instant clarifications or examples to enhance their understanding and ensure accuracy in their contract drafting. The AI module is preferably resident or accessible through the server 108 to reduce processing and storage footprint on each of mobile computing devices 102a-n.

When utilizing “easy mode,” the AI module simplifies the contract writing process for users who prefer a more guided approach. The AI module interacts directly with users by asking targeted questions based on the property details. For example, AI driven questions are operably configured to be presented to the users. Each of the question may be tailored to particular user and/or property. For example, upon selecting easy mode, users are presented with a series of questions generated by the AI module. These questions may be presented through or as part of the plurality of independent and sequentially viewable windows. These AI-generated questions are drawn from the property's listing information and remarks, ensuring relevance and specificity.

In one example, a question may be asked: (1) “What is the desired closing date for this property?”, (2) “Are there any contingencies you would like to include in the offer?”, and (3) “What financing options are you considering for this property?”. The AI module provides guided input, i.e., as users respond, the AI module dynamically populates corresponding sections of the contract, reducing the manual entry burden and minimizing errors. The AI module is operably configured provides explanations for each question, helping users understand why the information is essential for the contract. The AI module is also operably configured to provide contextual help. In particular, at any point during the process, but in particular during steps 305, 306, 307 depicted in FIG. 3, users can request additional information or clarifications. The AI module can offer insights into common practices, potential pitfalls, or legal considerations related to the questions being asked. In one embodiment, once the user answers all questions, the AI module is operably configured to compile information into a draft contract and suggests final edits, ensuring completeness and adherence to standard practices.

Said differently, by integrating an AI module into both the Do It Yourself Mode and Easy Mode, users can benefit from enhanced guidance, tailored recommendations, and a more streamlined contract drafting experience. This approach not only empowers users to create effective contracts but also fosters a better understanding of the process, ultimately leading to more informed decisions not accomplished with known systems and methods in the real estate market.

Said another way, the property listing workflow initiates when the user 104a selects a “Selling a Home” GUI icon 1000a-n from the main dashboard of the process 300. Upon selection, the server 108 transmits a plurality of sequential data-collection windows to the electronic display 210 of the first computing device 102a. A first such window solicits core property identification data, including but not limited to a property street address, city, state, zip code, contract number, and property type (e.g., single-family, condominium, townhouse, multi-family). A second data-collection window prompts the user 104a to input seller-side financial and condition disclosures, including the outstanding mortgage balance on the property, whether an appraisal has been completed on the property, the seller's motivation for selling, whether any liens exist on the property, and any items of personal property the seller intends to retain at closing. Each of these disclosure fields corresponds to a respective digital data input field 1100a-n, and the responses are stored in association with the array data structure described herein. A third data-collection window solicits a free-form text description allowing the seller to articulate unique features or attributes of the property being listed. This free-form entry field provides maximum flexibility to capture information not expressly captured by the structured input fields 1100a-n in the preceding windows. A final data-collection window for the property listing workflow prompts the user 104a to upload one or more digital photographs of the property via an image upload interface rendered on the electronic display 210, wherein the uploaded images are transmitted over the wireless communication network 106 to the computer server 108 and stored in association with the property listing data submitted by the user 104a.

A property search request workflow is initiated when the user 104a selects a “Buying a Home” GUI icon 1000a-n associated with requesting a curated list of available properties. A first data-collection window solicits buyer criteria including desired location (city, state, zip code), property type, price range, number of bedrooms, number of bathrooms, square footage, and garage preference, each captured in a respective digital data input field 1100a-n. The digital informational icon 4900 is positioned proximal to one or more of the digital data input fields 1100a-n, and upon selective modulation (e.g., tapping or hovering) by the user 104a, displays informational text to guide the user 104a in providing complete and accurate criteria. Additionally, a hyperlink or GUI icon is operable to allow the user 104a to access a buyer-detail intake form that enables the user 104a to provide additional financial and demographic information to the real estate professional, thereby facilitating a more targeted and refined list of available properties. A second data-collection window solicits supplemental buyer preferences, including alternative cities or geographic areas the user 104a is willing to consider, whether a crime report for the target area is desired, special accommodation requirements for the home (e.g., accessible design, custom layouts), and any additional free-form descriptive information. Upon completion of all data-collection windows in this workflow, the collected buyer criteria are transmitted to the computer server 108 and thereafter communicated to a real estate professional associated with the server 108 or otherwise accessible through the network 106, who will compile a customized property list responsive to the user's criteria. A confirmation page is then displayed on the electronic display 210, informing the user 104a that the submitted request has been received and that a professional will transmit the curated property list to the user's registered electronic contact information within a defined time period.

The consultation request workflow enables the user 104a to identify and contact a real estate professional by type of specialty. Specifically, the consultation request GUI presents the user 104a with selectable GUI icons 1000a-n corresponding to distinct categories of real estate professionals, including, but not limited to: a licensed real estate broker, a licensed real estate agent, a licensed mortgage broker, a real estate attorney, a title agent specialist, an appraiser, and an insurance agent. Upon selection by the user 104a, a consultation request message is transmitted over the wireless communication network 106 to the computer server 108 and routed to a professional of the selected type who is registered with or accessible through the server 108. The consultation request may include a timestamp of the request, the user's contact information stored in the user account, and a summary of the nature of the real estate transaction to facilitate a prompt and informed response from the selected professional. In one embodiment, the user 104a may also select a preferred mode of consultation (e.g., telephone, video conference, or in-person meeting), a preferred date and time range, and any additional notes or questions for the professional.

The direct messaging workflow provides the user 104a with a real-time, network-based digital communication channel between the user 104a and a real estate professional registered with or accessible through the computer server 108. The direct messaging interface, as rendered on the electronic display 210 of the first computing device 102a, displays a chronological message thread between the user 104a and the respective professional, and enables the user 104a to compose and transmit alpha-numeric text messages over the wireless communication network 106. In one embodiment, the direct messaging interface also supports transmission and receipt of digital file attachments, including but not limited to finalized digital documents generated by the process 300 (e.g., a completed real estate purchase and sale agreement), property listing data, or other relevant transaction documents. In a further embodiment, read receipts or delivery confirmations are displayed within the direct messaging interface to notify the user 104a when a transmitted message has been received and/or reviewed by the professional. In another embodiment, the direct messaging interface is persistent and session-independent, meaning that a prior message thread between the user 104a and a professional is preserved in the user account on the computer server 108 and accessible upon subsequent login by the user 104a, enabling continuity of communication across multiple sessions.

The property listing browsing workflow enables the user 104a to publish, browse, and review property listings directly through the process 300. In one embodiment, a property listing browsing page rendered on the electronic display 210 displays a listing card comprising a digital photograph of the property, the asking price, the property address, a listing date or days-on-market indicator, a garage count, and a selectable contact GUI icon operable to initiate a consultation request or direct message to the listing agent. Upon selection of a property listing card, the user 104a may be directed to a detailed property information page that displays extended listing details, including the property type, last sale date and price, year built, property tax information, and a plurality of property description features organized in a list format. The detailed property information page may also include an interactive property history section and a home value estimate section, providing the user 104a with additional market context to inform any contract formation decision. In one embodiment, the property listings accessible through the process 300 are populated from a database resident on or accessible through the computer server 108, which may be periodically updated with data received from one or more external property listing data sources communicatively coupled to the server 108 over the wireless communication network 106.

With respect to the “inquisitive analysis” step, the AI tool is operably configured to execute a natural language processing (NLP) algorithm that parses alpha-numeric text entered by the user 104a or extracted from an uploaded digital document, and identifies and classifies key contractual entities and parameters, including but not limited to: party identifiers (e.g., buyer and seller names), property identifiers (e.g., legal description, parcel identification number, address), financial terms (e.g., purchase price, earnest money deposit, down payment amount, loan amount), temporal terms (e.g., offer expiration date, closing date, inspection period duration), and conditional terms (e.g., contingencies, property condition representations, financing requirements). In one embodiment, the AI tool employs a named entity recognition (NER) model trained on a corpus of real estate contract language to perform said classification with a high degree of accuracy. Where a digital contract is uploaded by the user 104a (e.g., as a PDF or image file), the AI tool may further employ optical character recognition (OCR) to convert the document's content into machine-readable text prior to performing the NLP-based entity identification. The identified entities and parameters are stored as structured data in association with the array data structure and the respective array indices of the corresponding digital data input fields 1100a-n, ensuring accurate and complete mapping of extracted information to the appropriate fillable contract data fields.

With respect to the “intelligent summarization” step, the AI tool employs a summarization algorithm configured to condense the content of either a user-uploaded contract or the totality of contract formation data received from the user 104a through the plurality of digital data input fields 1100a-n into a concise, plain-language summary. In one embodiment, the summarization algorithm employs an abstractive summarization approach, wherein the AI tool generates a novel summary statement from the underlying content rather than merely extracting verbatim excerpts. The plain-language summary is then displayed to the user 104a within one or more of the independent and sequentially viewable windows as “contract formation text,” enabling the user 104a to quickly review and confirm the key terms of the transaction before the finalized digital document is generated. In an alternate embodiment, the summarization algorithm may employ an extractive summarization approach, wherein the most salient sentences or clauses from the contract or contract formation data are identified and presented to the user 104a as a structured summary. In a further embodiment, the AI tool is operable to translate the summarized content into a language other than English to accommodate users 104a-n for whom English is not the primary language, thereby broadening the accessibility and utility of the process 300.

With respect to the “streamlined contract formulation” step, once the inquisitive analysis and intelligent summarization steps have been completed, the AI tool is operably configured to assemble the finalized digital document by populating the plurality of independent preformed paragraphs with the contract formation data extracted, summarized, and validated during the preceding steps. In one embodiment, the AI tool executes a semantic coherence validation algorithm that evaluates the syntactic and semantic compatibility of each piece of contract formation data with its surrounding preformed paragraph text to ensure that, when inserted, the contract formation data produces grammatically correct, legally coherent, and contextually appropriate language within the finalized digital document. If the AI tool determines that a particular piece of contract formation data is inconsistent, ambiguous, or syntactically incompatible with its corresponding preformed paragraph, the AI tool is operably configured to suggest alternative phrasings, request clarification from the user 104a via a re-displayed input window, or autonomously rewrite the affected sentence or clause of the digital document to ensure clarity and legal precision. In one embodiment, the AI tool may also cross-reference the contract formation data against applicable jurisdictional real estate statutes and regulatory requirements stored in or accessible through a legal compliance database communicatively coupled to the server 108, and flag any contract formation data or generated contract terms that appear to be inconsistent with such requirements.

In the AI-augmented embodiment of the process 300, the first electronic computing device 102a of the first user 104a is communicatively coupled to the computer server 108 over the wireless communication network 106 using the network interface 204. The AI tool, or AI module, may be hosted on the computer server 108 and accessed via application programming interface (API) calls transmitted from the first computing device 102a to the server 108 over the network 106. Alternatively, in embodiments in which the first computing device 102a has sufficient processing capacity, a lightweight version of the AI tool, such as a compressed or quantized machine learning model, may be stored in the memory 206 of the first computing device 102a and executed locally by the first computing device 102a, thereby reducing latency and enabling at least partial AI-assisted contract formation functionality in low-connectivity environments. In a preferred embodiment, computation-intensive AI processing tasks (e.g., NER, summarization, and semantic coherence validation) are performed server-side on the computer server 108, while client-side AI processing is limited to lightweight inference tasks (e.g., real-time input validation and field formatting) to optimize performance across a range of computing device 102a-n hardware capabilities. The connectivity condition of the first computing device 102a determines the distribution of AI processing tasks between the first computing device 102a and the computer server 108.

Once the first electronic computing device 102a is communicatively coupled to the computer server 108 and the user 104a has been authenticated through the user account registration or login procedure described herein, the user 104a initiates either the network-based remote “easy” contract formation session or the network-based remote “do-it-yourself” contract formation session. In the AI-augmented “easy” contract formation session, the computer server 108 transmits session initialization data to the first computing device 102a, including a session identifier, an ordered sequence of the independent and sequentially viewable windows to be displayed on the electronic display 210, and any pre-populated contract formation text or preliminary AI-generated suggestions derived from prior user activity or property data accessible to the server 108. In one embodiment, if the user 104a has previously saved a partially completed contract in the user account, the server 108 retrieves the stored contract formation data from the user account database and pre-populates the corresponding digital data input fields 1100a-n with the previously entered data, allowing the user 104a to resume the process 300 from the point of prior termination without re-entering previously submitted information.

In one embodiment, each of the plurality of independent and sequentially viewable windows is rendered on the electronic display 210 of the first computing device 102a as a distinct, full-screen or partial-screen GUI panel that presents a discrete subset of the digital data input fields 1100a-n associated with the overall contract formation process 300. The partitioning of the digital data input fields 1100a-n across the plurality of independent windows is determined by a pre-programmed window sequencing algorithm resident on the computer server 108, which groups related digital data input fields 1100a-n into logical clusters (e.g., party identification fields, property description fields, financial terms fields, contingency fields, and closing-condition fields) and assigns each cluster to a dedicated window in the sequence. This grouping and sequencing architecture reduces cognitive overload for the user 104a by limiting the volume of information presented at any one time and presenting the digital data input fields 1100a-n in an order that mirrors the logical structure of a real estate purchase and sale agreement. In one embodiment, the number of independent windows in the sequence, and the assignment of digital data input fields 1100a-n to each window, may vary based on the type of real estate transaction selected by the user 104a via the plurality of GUI icons 1000a-n (e.g., a residential purchase transaction may involve a different number and sequence of windows than a commercial lease transaction).

Navigation between the plurality of independent and sequentially viewable windows is controlled by selectable “BACK” and “CONTINUE” (or equivalent) GUI navigation icons rendered on the electronic display 210 at the bottom of each window. Upon selection of the “CONTINUE” GUI navigation icon, the contract formation data entered in the active window is transmitted from the first computing device 102a to the computer server 108, or in one embodiment, stored locally in the memory 206 of the first computing device 102a for batch transmission upon completion of all windows, for validation prior to advancing to the next sequential window. The computer server 108 executes a real-time data validation routine upon receipt of the contract formation data for each window, which checks each digital data input field 1100a-n for: (i) completeness-whether the field has been populated; (ii) data-type conformance-whether a date field contains a valid date, whether a numeric field contains a numeric value, and whether a state field contains a valid state abbreviation; and (iii) logical consistency-whether, for example, the offer expiration date is later than the contract execution date, whether the down payment amount does not exceed the purchase price, and whether the closing date is later than the offer date. If the validation routine identifies one or more errors or omissions, the server 108 transmits an error notification to the first computing device 102a, which is displayed on the electronic display 210 as an in-window alert message identifying the specific digital data input field(s) 1100a-n requiring correction before the user 104a may proceed to the next window.

The software-based learning tool referenced herein is implemented as a software module resident on the computer server 108 and comprises, in one embodiment, a learning data structure that includes a plurality of pre-programmed acceptable response patterns for each of the digital data input fields 1100a-n in the process 300. Each acceptable response pattern is associated with the array index of its corresponding digital data input field 1100a-n and defines the set of alpha-numeric text strings, or categories thereof, that represent semantically valid and contextually appropriate responses to the contract formation text displayed in the associated independent window. In a first embodiment, the learning data structure is implemented as a hash map or associative array, wherein each key corresponds to the array index of a digital data input field 1100a-n, and each value is a set of pre-programmed valid response strings or a pre-programmed response classification rule (e.g., “must be a positive integer,” “must be a valid U.S. state abbreviation,” “must be a date in MM/DD/YYYY format”). In a second embodiment, the learning data structure is implemented as a trained machine learning classifier (e.g., a decision tree classifier, a support vector machine, or a neural network-based text classifier) that assigns a probability score to the contract formation data entered by the user 104a, representing the likelihood that the entered data constitutes a semantically valid response to the associated contract formation text.

When the user 104a enters contract formation data into a digital data input field 1100a-n and selects the “CONTINUE” GUI navigation icon to advance to the next sequential window, the software-based learning tool is executed to ascertain the contract formation data entered by the user 104a and compare it to the learning data structure to determine whether a “match” exists. A “match,” as used herein, encompasses: (a) an exact string match between the entered contract formation data and a pre-programmed valid response string in the learning data structure; (b) a pattern match between the entered contract formation data and a pre-programmed response classification rule in the learning data structure; (c) in the machine learning classifier embodiment, a probability score for the entered contract formation data that meets or exceeds a pre-programmed classification confidence threshold; and (d) a close-match, wherein the entered data contains a common misspelling of a valid response term that can be resolved with a high degree of confidence by the learning data structure. If a match is detected, the contract formation data is accepted, stored in the array data structure under the corresponding array index, and the user 104a advances to the next sequential window.

In the event that the software-based learning tool determines that the contract formation data entered by the user 104a does not constitute a “match” or “close match” with the learning data structure (i.e., a “non-match” condition is detected), the software-based learning tool is operably configured to initiate one or more corrective actions in an escalating sequence. In a first corrective action, the software-based learning tool causes the first computing device 102a to display a re-entry prompt on the electronic display 210, requesting that the user 104a re-enter contract formation data into the affected digital data input field 1100a-n. In a second corrective action, triggered upon repeated failure at the first corrective action, the software-based learning tool causes the first computing device 102a to redisplay the contract formation text associated with the affected independent window in a revised or simplified form, using alternate language, a concrete example, or an explanatory annotation intended to improve the user's comprehension of the type of information required by the digital data input field 1100a-n. In a third corrective action, triggered upon further repeated failure, the software-based learning tool causes the digital informational icon 4900 proximal to the affected digital data input field 1100a-n to automatically display its associated informational text on the electronic display 210 without requiring selective modulation by the user 104a, thereby providing the user 104a with immediate contextual guidance. These corrective actions may be applied individually or in combination, and the software-based learning tool may be programmed to escalate from the first through the third corrective action upon repeated non-match conditions for the same digital data input field 1100a-n within a single session. Each non-match event is recorded and transmitted to the computer server 108 for use in the autonomous learning update process described herein.

The software-based learning tool is further configured to autonomously update the learning data structure over time based on aggregate non-match data submitted by the plurality of users 104a-n across a plurality of network-based remote “easy” contract formation sessions. Specifically, when a non-match event is logged, the server 108 monitors the frequency with which that specific non-matched text string is submitted across contract formation sessions. When the occurrence threshold is met—i.e., the text string has been submitted as a non-matching response by two or more different users 104a-n or across two or more different contract formation sessions—the text string is identified as a candidate valid response. The candidate response is then subjected to a review and approval process administered by an authorized system administrator before being incorporated into the live learning data structure, in order to prevent erroneous or malicious data entries from corrupting the integrity of the learning data structure. If the administrator approves the candidate response, the learning data structure is updated to add the newly approved text string as an acceptable response pattern under the array index of the corresponding digital data input field 1100a-n. The updated learning data structure is then propagated in real time or near real time from the computer server 108 over the wireless communication network 106 to all software-based learning tool instances executing across the plurality of computing devices 102a-n, ensuring that all users 104a-n benefit simultaneously from the expanded learning data structure.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above described features.

What is claimed is:

1. A computer-implemented and interactive real estate contract generation and editing process comprising the steps of:
providing a first electronic computing device of a first user and a computer server;
communicatively coupling the first electronic computing device of the first user to the computer server over a wireless communication network and generating a digital graphical user interface (GUI) on an electronic display of the first computing device with a plurality of digital data input fields operably configured to receive alpha-numeric text, each identified by an assigned array index on an array data structure, and with a plurality of GUI icons, a digital informational icon disposed proximal to each of the plurality of digital data input fields, and having informational text included therein, the digital informational icon displaying the informational text on the electronic display of the first computing device upon selectively modulating the digital informational icon;
initiating a network-based remote easy contract formation session that includes generating a plurality of GUI icons each relating to a type of real estate transaction the user is seeking to prepare and generating, after selection of one of the plurality of GUI icons, a plurality of independent and sequentially viewable windows and selecting, within the plurality of independent and sequentially viewable windows, another plurality of GUI icons on the electronic display of the first computing device and inputting contract formation data into each of the plurality of digital data input fields; and
generating, after completion of the plurality of independent and sequentially viewable windows and at a conclusion of the network-based remote easy contract formation session, a digital document in the network-based remote easy contract formation session with a plurality of independent preformed paragraphs each having at least one fillable contract data field disposed therein and assigned to, using an array data structure with the assigned array index, and filled in with contract formation data to one of the plurality of digital data input fields within the plurality of independent and sequentially viewable windows to create a finalized digital document without any fillable contract data field therein and that is downloadable to the electronic display of the first computing device.
